(19) United States
(12) Patent Application Publication
(10) Pub. No.: US 2023/0121100 A1
(43) Pub. Date: Apr. 20, 2023

(54) PRECERAMIC POLYMER 3D-PRINTING FORMULATION COMPRISING FUMED ALUMINA

(71) Applicant: University of Tennessee Research Foundation, Knoxville, TN (US)

(72) Inventors: Brett Gibson Compton, Knoxville (US); James William Kemp, Dayton (US); Stian Kristov Romberg, Maryville, TN (US); Jesse Lynn Reed, Clinton, TN (US)

(73) Assignee: University of Tennessee Research Foundation, Knoxville (US)

(21) Appl. No.: 17/967,634

(22) Filed: Oct. 17, 2022

Related U.S. Application Data
(60) Provisional application No. 63/256,187, filed on Oct. 15, 2021.

(51) Int. Cl. C04B 35/571; B28B 1/00; C04B 35/78

(52) U.S. Cl. CPC C04B 35/571; B28B 1/001; C04B 35/78; C04B 2235/483; C04B 2235/3217; C04B 2235/3826; C04B 2235/3813; C04B 2235/524; B33Y 10/00

(57) ABSTRACT

Compositions comprising preceramic resins and fumed alumina are described. The compositions can also include fillers, such as silicon carbide whiskers or zirconium diboride particles. The compositions can be used as three-dimensional printable inks for preparing ceramic composites, e.g., composites having complex geometry. Inclusion of fumed alumina as a rheology modifier in the composition can provide improved printing properties for the inks compared to preceramic resin inks that do not include fumed alumina.

### RELATED APPLICATIONS

The presently disclosed subject matter claims the benefit of U.S. Provisional Patent Application Ser. No. 63/256,187, filed Oct. 15, 2021; the disclosure of which is incorporated herein by reference in its entirety.

### GRANT STATEMENT

This invention was made with government support under Grant No. DE-NA0002839 awarded by the Department of Energy. The government has certain rights in the invention.

### TECHNICAL FIELD

The presently disclosed subject matter relates in some embodiments to preceramic resin ink compositions for use, for example, in additive manufacturing (AM) applications (e.g., direct ink writing (DIW)) and to the ceramic objects prepared using the inks. The inks comprise preceramic resins and fumed alumina (i.e., fumed Al₂O₃, also abbreviated as FA). The inks can further include one or more optional filler materials, such as, but not limited to, silicon carbide whiskers (SiC_{w}) or zirconium diboride (ZrB₂) particles. The presently disclosed subject matter further relates to methods of using the inks to prepare ceramic objects.

### BACKGROUND

Polymer-derived ceramics (PDCs) are a class of ceramic materials formed from the conversion of polymeric precursors to inorganic ceramics. This class of materials has been of interest in recent years because of their ability to form complex structures. The majority of commercially available polymeric precursors for PDCs are precursors for silicon oxycarbide (SiOC), silicon carbonitride (SiCN), silicon carbide (SiC), and silicon nitride (Si₃N₄) materials.

While still in the polymeric phase, the precursors for PDCs can behave similarly to thermoset polymers that thermally cross-link. See Colombo et al. (2010); and Greil (2000). During the cross-linking phase, many low-molecular-weight oligomers and various hydrocarbon gasses (methane, ethanol, ammonia, etc.) diffuse out of the formed polymer. See Apostolov et al. (2020); and Key et al. (2018). This is commonly referred to as “off-gassing,” and can lead to porosity development in the PDC part being manufactured, which can be detrimental to the strength and performance of the final part. See Apostolov et al. (2020); and Kemp et al. (2021).

For instance, DM-printed structures prepared from polycarbosilane-based inks can develop large porous networks after curing. See Kemp et al. (2021). Methods to mitigate the development of the porous networks have been explored, including thermal pre-treatment, addition of a chemical initiator, and synthetic refinement of the polymer. For example, a thermal pre-treatment process studied with a polycarbosilane resin and a polysilazane resin showed that low-molecular-weight oligomers present in the polymer can be removed with a combination of heat and vacuum. See Apostolov et al. (2020). With the addition of a chemical initiator, i.e., dicumyl peroxide, to a polysilazane resin, many low molecular weight oligomers and methyl/vinyl groups could be pulled off prior to thermal cross-linking. See D'Elia et al. (2018). However, a description of how these mitigation strategies influence porosity in cured and pyrolyzed materials is limited.

Accordingly, there is an ongoing need for additional preceramic ink compositions for AM applications and methods of using the inks to prepare ceramic objects.

### SUMMARY

This Summary lists several embodiments of the presently disclosed subject matter, and in many cases lists variations and permutations of these embodiments. This Summary is merely exemplary of the numerous and varied embodiments. Mention of one or more representative features of a given embodiment is likewise exemplary. Such an embodiment can typically exist with or without the feature(s) mentioned; likewise, those features can be applied to other embodiments of the presently disclosed subject matter, whether listed in this Summary or not. To avoid excessive repetition, this Summary does not list or suggest all possible combinations of such features.

In some embodiments, the presently disclosed subject matter provides a composition comprising: (a) a preceramic resin; and (b) a rheology modifier, wherein the rheology modifier comprises a fumed alumina. In some embodiments, the fumed alumina comprises hydrophobic fumed alumina.

In some embodiments, the composition further comprises one or more fillers. In some embodiments, the one or more fillers comprise a composition selected from the group comprising zirconia, alumina, silicon carbide, silicon nitride, aluminum nitride, boron nitride, titanium diboride, boron carbide, zirconium diboride (ZrB₂), carbon, an oxide, and titanium carbide. In some embodiments, the one or more fillers comprise ZrB₂ particles or silicon carbide whiskers.

In some embodiments, the preceramic resin comprises a polycarbosilane resin or a polysilazane resin.

In some embodiments, the composition comprises about 40 percent by volume (vol %) to about 97 vol % preceramic resin. In some embodiments, the composition comprises about 3 vol % to about 25 vol % fumed alumina. In some embodiments, the composition comprises about 4 vol % to about 17 vol % fumed alumina.

In some embodiments, the composition comprises about 51.7 vol % polycarbosilane resin; about 5.95 vol % fumed alumina; and about 42.4 vol % zirconium diboride filler. In some embodiments, the composition comprises about 66.7 vol % polycarbosilane resin; about 16.45 vol % fumed alumina; and about 16.8 vol % silicon carbide whiskers. In some embodiments, the composition comprises about 66.1 vol % polysilazane resin; about 16.8 vol % fumed alumina; and about 17.1 vol % silicon carbide whiskers.

In some embodiments, the presently disclosed subject matter provides a method of preparing a ceramic object, the method comprising: (a) printing a composition comprising a preceramic resin and a rheology modifier, wherein the rheology modifier comprises a fumed alumina; and (b) curing and pyrolyzing the ink composition to provide the ceramic object.

In some embodiments, the presently disclosed subject matter provides a ceramic object prepared by a method comprising: (a) printing a composition comprising a preceramic resin and a rheology modifier, wherein the rheology modifier comprises a fumed alumina; and (b) curing and pyrolyzing the ink composition to provide the ceramic object. In some embodiments, the ceramic object has a higher flexural strength and/or Weibull modulus than a ceramic object of the same size prepared from an ink composition not including fumed alumina.

In some embodiments, the presently disclosed subject matter provides a ceramic object comprising a pyrolyzed composition of a composition comprising a preceramic resin and a rheology modifier, wherein the rheology modified comprises a fumed alumina. In some embodiments, the ceramic object has a higher flexural strength and/or Weibull modulus than a ceramic object of the same size prepared from an ink composition not including fumed alumina.

In some embodiments, the presently disclosed subject matter provides a ceramic object comprising a ceramic matrix and fumed alumina. In some embodiments, the ceramic object further comprises one or more fillers, wherein the one or more fillers comprise a composition selected from the group comprising zirconia, alumina, silicon carbide, silicon nitride, aluminum nitride, boron nitride, titanium diboride, boron carbide, ZrB₂, carbon, an oxide, and titanium carbide. In some embodiments, the ceramic object further comprises ZrB₂ particles or silicon carbide whiskers.

Accordingly, it is an object of the presently disclosed subject matter to provide preceramic resin-based compositions, related methods of preparing ceramic objects, and the ceramic objects themselves. An object of the presently disclosed subject matter having been stated hereinabove, and which is achieved in whole or in part by the presently disclosed subject matter, other objects will become evident as the description proceeds when taken in connection with the accompanying drawings and examples as best described herein below.

### BRIEF DESCRIPTION OF THE DRAWINGS

FIGS. 1A and 1B: Graphs showing rheological behavior of a preceramic ink composition comprising a polycarbosilane and fumed alumina (SMP-FA) and of a preceramic ink composition comprising the same polycarbosilane but not including the fumed alumina (SMP-00). FIG. 1A is a graph showing apparent viscosity (in pascal-seconds (Pa·s)) vs. shear rate (in reciprocal seconds (1/s)). Experimental values for SMP-00 are shown in filled circles. Experimental values for SMP-FA are shown in unfilled squares. Linear regression is shown by dotted line. FIG. 1B is a graph showing shear moduli vs. oscillatory shear stress (both in pascals (Pa)). Storage modulus for SMP-00 is shown by filled circles, while that for SMP-FA in filled squares. Loss modulus for SMP-00 is shown by unfilled circles, while that for SMP-FA in unfilled squares.

FIGS. 2A and 2B: Graphs showing heat flow of reaction (left, in watts per gram (W/g)) and mass loss (right, in weight percentage (wt. %)) versus temperature (in degrees Celsius (° C.) for (FIG. 2A) the uncured preceramic inks described for FIGS. 1A and 1B (SMP-FA and SMP-00) and neat polycarbosilane (PCS) resin up to 300° C., and (FIG. 2B) the corresponding cured specimens up to 1200° C. The boxed legend in the upper left of each graph shows the line pattern for mass loss data for each sample (i.e., solid line for SMP-FA, dotted line for SMP-00, and dashed line for neat PCS), while the data for heat flow of reaction for each sample is indicated by lead lines.

FIGS. 3A and 3B: Composite micrographs showing bubble formation on the bottom part of microrods printed with the preceramic ink compositions described for FIGS. 1A and 1B. FIG. 3A shows specimens printed from a preceramic ink composition comprising a polycarbosilane (PCS) resin that did not include fumed alumina (SMP-00) and FIG. 3B shows specimens printed from a preceramic ink composition comprising PCS resin and fumed alumina (SMP-FA). Nozzle diameter used for printing for both FIG. 3A and FIG. 3B increases from the left to right from 0.450 millimeters (mm) to 1.702 mm. Width of the deposited rod (“road width”) also increase from left to right in each of FIGS. 3A and 3B. Scale bar in the upper right of FIG. 3B represents 1 millimeter (mm).

FIGS. 4A and 4B: Porosity composition images of printed and pyrolyzed microrods printed with a 1.702 millimeter (mm) nozzle using a preceramic ink composition comprising a polycarbosilane resin and fumed alumina (SMP-FA). FIG. 4A is the original image and FIG. 4B is the binary image of porosity (pores are white dots). The scale bar in the lower right corner of each figure represents 1000 microns (μm).

FIGS. 5A and 5B: Histograms showing the frequency of effective bubble radii (in microns (μm) for the bottom surface of pyrolyzed microrods printed with (FIG. 5A) a preceramic ink composition comprising polycarbosilane resin without fumed alumina (SMP-00) and (FIG. 5B) a preceramic ink composition comprising the same polycarbosilane resin and containing fumed alumina (SMP-FA) where the ink compositions were deposited using different nozzle diameters: 634 microns (μm), 979 μm, 1346 μm, and 1702 μm.

FIGS. 6A-6F: Optical images of pyrolyzed fracture surfaces of microrods printed from a preceramic ink composition comprising a polycarbosilane resin without fumed alumina (SMP-00). Deposition nozzle diameters used were (FIG. 6A) 450 microns (μm), (FIG. 6B) 634 μm, (FIG. 6C) 979 μm, (FIG. 6D) 1346 μm, and (FIG. 6E) 1702 μm. FIG. 6F is scanning electron microscopy (SEM) image of the boxed region of the bar shown in FIG. 6E. The scale bar in FIGS. 6A-6E represents 100 micrometers (μm). The scale bar in FIG. 6F represents 10 μm.

FIGS. 7A-7F: Optical images of pyrolyzed fracture surfaces of microrods printed from a preceramic ink composition comprising a polycarbosilane resin and fumed alumina (SMP-FA). Deposition nozzle diameters used were (FIG. 7A) 450 microns (μm), (FIG. 7B) 634 μm, (FIG. 7C) 979 μm, (FIG. 7D) 1346 μm, and (FIG. 7E) 1702 μm. FIG. 7F is a scanning electron microscopy (SEM) image of a region of the bar shown in FIG. 7E. The scale bar in FIGS. 7A-7E represents 100 micrometers (μm). The scale bar in FIG. 7F represents 10 μm.

FIG. 8: A graph of failure strength (σ_{f}, in megapascals (MPa)) as a function of cross-sectional area (Ac, in square millimeters (mm²)) for ceramic bars printed from a preceramic ink composition comprising a polycarbosilane resin without fumed alumina (SMP-00, circles) and a preceramic ink composition comprising the polycarbosilane resin and fumed alumina (SMP-FA, squares) using different nozzle diameters: 450 microns (m), 634 μm, 979 μm, 1346 μm, and 1702 μm.

FIGS. 9A and 9B: Weibull plots of failure strength (σ_{f}, in megapascals (MPa)) of ceramic bars printed from (FIG. 9A) a preceramic ink composition comprising polycarbosilane resin without fumed alumina (SMP-00) and (FIG. 9B) a preceramic ink composition comprising the polycarbosilane resin and fumed alumina (SMP-FA) using different nozzle diameters: 450 microns (m), 634 μm, 979 μm, 1346 μm, and 1702 μm.

FIGS. 10A and 10B: Optical images of rods printed with a preceramic ink composition comprising a polycarbosilane resin and including fumed alumina (SMP-FA) deposited with a 1702 μm nozzle after (FIG. 10A) curing or (FIG. 10B) curing and pyrolysis. The cured only specimen (FIG. 10A) has observable pores, while the cured and pyrolyzed specimen (FIG. 10B) has interlocking cracks connecting the pores. The samples shown in FIGS. 10A and 10B are different microrods, but are made with the same ink, and cured identically. The scale bar in the bottom right of FIG. 10B represents 1 millimeter (mm).

FIGS. 11A and 11B: FIG. 11A is a pair of optical images providing a side-by-side comparison of fracture surfaces of ceramic microbars printed using a preceramic ink composition comprising a polycarbosilane resin without fumed alumina (SMP-00, image on right) and a preceramic ink composition comprising the polycarbosilane resin and fumed alumina (SMP-FA, image on left). FIG. 11B is a graph showing the Vickers harness (in gigapascals (GPa) of the outer (Outside SMP-00) and inner (Inside SMP-00) regions of the SMP-00 bar and of the SMP-FA bar shown in FIG. 11A.

FIG. 12 is a pair of optical images showing the tops (left image) and bottoms (right image) of exemplary ceramic bars printed using a preceramic ink comprising a polycarbosilane resin, fumed alumina, and silicon carbide whiskers (SMP-75/FA/SiC) after pyrolysis.

FIGS. 13A and 13B: Graphs showing simultaneous differential scanning calorimetry (DSC, as heat flow, left) and thermogravimetric analysis (TGA, as weight percent, right) of uncured ink compositions. FIG. 13A shows simultaneous DSC/TGA over a temperature range of room temperature to 1200 degrees Celsius (° C.) for two different ink formulations, SMP-10 (dotted lines), which is the same composition as “SMP-FA” in FIGS. 7A-7F; and SMP-75 (solid lines), which comprises: a polycarbosilane resin with a higher ratio of carbon to silicon in its backbone compared to the polycarbosilane resin in SMP-10, fumed alumina (FA), and silicon-carbide (SiC) whiskers. FIG. 13B focuses on a temperature range of room temperature to 300° C.

FIG. 14: A pair of optical images showing exemplary bars printed using a preceramic ink composition comprising a polysilazane, fumed alumina, and silicon carbide whiskers after curing.

FIG. 15: A schematic diagram showing the chemical structures of classes of preceramic polymers. Adapted from Colombo et al. (Jour. Amer. Ceram. Soc. (2010), 4, 245-320).

### DETAILED DESCRIPTION

According to one aspect of the presently disclosed subject matter, preceramic resin-based compositions (e.g., compositions for additive manufacturing and/or ink compositions), related methods of preparing ceramic objects, and the ceramic objects prepared thereby are disclosed. The compositions can also include additional filler components, such as, inorganic or carbon particles or fibers, including but not limited to, fillers comprising zirconia, alumina, silicon carbide (e.g., silicon carbide particles, fibers, or whiskers), aluminum nitride, boron nitride, silicon nitride, titanium diboride, boron carbide, titanium carbide, carbon (e.g., carbon fibers), an oxide (e.g., an oxide fiber), and/or zirconium diboride.

In some embodiments, the fumed alumina has a surface treatment (such as but not limited to functionalization of the surface) that makes the fumed alumina hydrophobic. In some embodiments, this aids in dispersion within the polymer resin. Indeed, in some embodiments, the use of fumed alumina as a viscosifier/rheology modifier in the presently disclosed inks can impart excellent printing behavior to the preceramic resins. In addition, alumina has much better properties at high temperature compared to fumed silica or nanoclay, which are the other viscosifier/rheology modifiers typically used in thermoset inks for 3D printing.

As described hereinbelow, exemplary ceramic microrods of varying diameters were printed using inks comprising preceramic resins and fumed alumina (fumed Al₂O₃ or FA). For example, polycarbosilane (PCS)-based inks loaded with zirconium diboride (ZrB₂) and FA and the microrods printed therefrom are described. The effects of deposition nozzle diameter and ink composition were characterized and analyzed with Weibull analysis. Porosity content was quantified through area analysis, and the strength of individual microrods was measured with 3-point bend testing.

The presently disclosed subject matter will now be described more fully. The presently disclosed subject matter can, however, be embodied in different forms and should not be construed as limited to the embodiments set forth herein below and in the accompanying Examples. Rather, these embodiments are provided so that this disclosure will be thorough and complete, and will fully convey the scope of the embodiments to those skilled in the art.

### I. Definitions

While the following terms are believed to be well-understood by one of ordinary skill in the art, the following definitions are set forth to facilitate explanation of the presently disclosed subject matter.

Unless defined otherwise, all technical and scientific terms used herein have the same meaning as commonly understood to one of ordinary skill in the art to which the presently disclosed subject matter belongs.

Following long-standing patent law convention, the terms “a”, “an”, and “the” refer to “one or more” when used in this application, including the claims.

The term “and/or” when used in describing two or more items or conditions, refers to situations where all named items or conditions are present or applicable, or to situations wherein only one (or less than all) of the items or conditions is present or applicable.

The use of the term “or” in the claims is used to mean “and/or” unless explicitly indicated to refer to alternatives only or the alternatives are mutually exclusive, although the disclosure supports a definition that refers to only alternatives and “and/or.” As used herein “another” can mean at least a second or more.

The term “comprising”, which is synonymous with “including,” “containing,” or “characterized by” is inclusive or open-ended and does not exclude additional, unrecited elements or method steps. “Comprising” is a term of art used in claim language which means that the named elements are essential, but other elements can be added and still form a construct within the scope of the claim.

As used herein, the phrase “consisting of” excludes any element, step, or ingredient not specified in the claim. When the phrase “consists of” appears in a clause of the body of a claim, rather than immediately following the preamble, it limits only the element set forth in that clause; other elements are not excluded from the claim as a whole.

As used herein, the phrase “consisting essentially of” limits the scope of a claim to the specified materials or steps, plus those that do not materially affect the basic and novel characteristic(s) of the claimed subject matter.

With respect to the terms “comprising”, “consisting of”, and “consisting essentially of”, where one of these three terms is used herein, the presently disclosed and claimed subject matter can include the use of either of the other two terms.

Unless otherwise indicated, all numbers expressing quantities of time, temperature, light output, atomic (at) or mole (mol) percentage (%), and so forth used in the specification and claims are to be understood as being modified in all instances by the term “about”. Accordingly, unless indicated to the contrary, the numerical parameters set forth in this specification and attached claims are approximations that can vary depending upon the desired properties sought to be obtained by the presently disclosed subject matter.

As used herein, the term “about”, when referring to a value is meant to encompass variations of in one example ±20% or ±10%, in another example ±5%, in another example ±1%, and in still another example ±0.1% from the specified amount, as such variations are appropriate to perform the disclosed methods.

Numerical ranges recited herein by endpoints include all numbers and fractions subsumed within that range (e.g. 1 to 5 includes 1, 1.5, 2, 2.75, 3, 3.90, 4, 4.24, and 5). Similarly, numerical ranges recited herein by endpoints include subranges subsumed within that range (e.g. 1 to 5 includes 1-1.5, 1.5-2, 2-2.75, 2.75-3, 3-3.90, 3.90-4, 4-4.24, 4.24-5, 2-5, 3-5, 1-4, and 2-4).

As used herein, a “monomer” refers to a molecule that can undergo polymerization, thereby contributing constitutional units, i.e., an atom or group of atoms, to the essential structure of a macromolecule.

As used herein, a “macromolecule” refers to a molecule of high relative molecular mass, the structure of which comprises the multiple repetition of units derived from molecules of low relative molecular mass, e.g., monomers and/or oligomers.

An “oligomer” refers to a molecule of intermediate relative molecular mass, the structure of which comprises a small plurality (e.g., 2, 3, 4, 5, 6, 7, 8, 9, or 10) of repetitive units derived from molecules of lower relative molecular mass.

A “polymer” refers to a substance comprising macromolecules. In some embodiments, the term “polymer” can include both oligomeric molecules and molecules with larger numbers (e.g., >10, >20, >50, >100) of repetitive units. In some embodiments, “polymer” refers to macromolecules with at least 10 repetitive units.

A “copolymer” refers to a polymer derived from more than one species of monomer.

The term “resin” when used with regard to a thermosetting or preceramic polymer can refer to a polymer precursor or a mixture of polymer precursors that can be further cured (i.e., via further polymerization and/or crosslinking).

The terms “thermoset” and “thermosetting” can refer to a polymer that is irreversibly formed when polymer precursors (e.g., monomers and/or oligomers) react with one another when exposed to heat, suitable radiation (e.g., visible or ultraviolet light), and/or suitable chemical conditions (e.g., the addition of a chemical polymerization initiator or catalyst (e.g. a peroxide) and/or exposure to suitable pH conditions (such as brought about by the addition of an acid or base)). In contrast, a thermoplastic polymer is a polymer that softens and/or can be molded above a certain temperature but is solid below that temperature.

The terms “cure”, “curing”, and “cured” as used herein can refers to the hardening of a preceramic resin (e.g. via polycondensation or cross-linking of polymer chains). Curing can be done thermally (e.g., at temperatures of about 100° C. to about 300° C., or at temperatures of about 200° C. to about 230° C.), chemically, or via application of ionizing radiation, such as but not limited to electron beam, x-ray, gamma, photo with photo initiators, and/or ultraviolet (UV)).

The term “additive manufacturing” or “AM” as used herein refers to a process wherein successive layers of material are laid down under computer control. The three-dimensional objects can be prepared using additive manufacturing having almost any shape or geometry and can be produced from a model or other electronic data source. AM methods can include, but are not limited to, sintering of metallic or thermoplastic particles, fused deposition modeling, stereolithography, laminated object manufacturing, and direct ink writing (DIW) of polymer fluid resins and aqueous slurries. In a typical DIW process, a curable composition (or “ink”) can be loaded into a print head that can extrude the curable composition. The print head can comprise an extruder, such as a syringe, attached to a nozzle that can deposit a thin line (or “bead”) of the curable composition, e.g., as directed by a computer. For example, the print head can be mounted on a computer numeric controlled (CNC) machine with controlled motion along at least the x-, y- and z-axes.

The term “ink” as used herein refers to an ink for use in a manufacturing process, such as an additive manufacturing process, that can be “written”, extruded, printed or otherwise deposited to form a layer that substantially retains its as-deposited geometry and shape with perhaps some, but preferably not excessive, sagging, slumping, or other deformation, even when deposited onto other layers of ink, and/or when other layers of ink are deposited onto the layer. As such, skilled artisans will understand the ink can exhibit appropriate rheological properties to allow the formation of monolithic structures via deposition of multiple layers of the ink (or in some cases multiple inks with different compositions) in sequence. More particularly, the terms “ink”, “ink composition” and “ink formulation” as used herein refer in some embodiments to a curable liquid composition or slurry comprising a preceramic polymer that can be extruded from a nozzle (e.g., during a DIW application). Printable inks can be quantified by measuring how shear-thinning they are and what their yield stress (Ty) behavior is under an applied load.

The term “nano” as in “nanoparticles” as used herein refers to a structure having at least one region with a dimension (e.g., length, width, diameter, etc.) of less than about 1,000 nm. In some embodiments, the dimension is smaller (e.g., less than about 500 nm, less than about 250 nm, less than about 200 nm, less than about 150 nm, less than about 125 nm, less than about 100 nm, less than about 80 nm, less than about 70 nm, less than about 60 nm, less than about 50 nm, less than about 40 nm, less than about 30 nm or even less than about 20 nm). In some embodiments, the dimension is between about 20 nm and about 250 nm (e.g., about 20, 30, 40, 50, 60, 70, 80, 90, 100, 110, 120, 130, 140, 150, 160, 170, 180, 190, 200, 210, 220, 230, 240, or 250 nm).

The term “micro” as in “microparticles” as used herein refers to a structure having at least one region with a dimension (e.g., a length, width, diameter, etc.) of less than 1000 microns (μm), but at least about 1 μm. In some embodiments, the dimension is smaller (e.g., less than about 500 μm, less than about 250 μm, less than about 200 μm, less than about 150 μm, less than about 125 μm, less than about 100 μm, less than about 80 μm, less than about 70 μm, less than about 60 μm, less than about 50 μm, less than about 40 μm, less than about 30 μm or even less than about 20 μm). In some embodiments, the dimension is between about 20 μm and about 250 μm (e.g., about 20, 30, 40, 50, 60, 70, 80, 90, 100, 110, 120, 130, 140, 150, 160, 170, 180, 190, 200, 210, 220, 230, 240, or 250 μm).

In some embodiments, the nano- or microparticles described herein can be approximately spherical. When the particles are approximately spherical, the characteristic dimension can correspond to the diameter of the sphere. In addition to spherical shapes, the particles can be disc-shaped, plate-shaped, oblong, polyhedral, rod-shaped, cubic, or irregularly-shaped. In some embodiments, the particles are fibers (e.g., rod-shaped particles with an aspect ratio greater than 3) or whiskers (fibers with a diameter of less than 5 microns, e.g., between about 0.5 microns and about 1 microns).

### II. Representative Embodiments

Preceramic polymers are of interest for use in many manufacturing techniques such as injection molding, ceramic fiber infiltration, and additive manufacturing. However, off-gassing of low molecular weight oligomers can occur when these polymers cure, leading to porosity in the cured part.

In the context of AM, there are few, if any, studies at present that investigate how print parameters affect the development of porosity in preceramic polymer inks. Franchin et al. measured mechanical properties of individual preceramic polymer filaments (see Franchin et al. (2018)), and others have shown properties of printed 3 point and 4 point flexural bars (see Xiao et al. (2020)), but no research has studied how sample size affects the development of porosity and mechanical strength in polymer-derived ceramics. Traditionally, ceramic test specimens made with conventional ceramic processing methods with different volumes and mechanical strengths have been analyzed through Weibull statistical analysis. See Quinn and Quinn (2010); and Wachtman et al. (2009). Intrinsic and extrinsic flaws usually dictate the brittle failure of ceramics, and with increased material volume, there is an increased likelihood of a strength-limiting flaw being present in a ceramic. By using a Weibull distribution fit, the effects of flaw size distribution and sample volume can be accounted for by determining a Weibull modulus, or a measure of the sample's likelihood of failure. See Wachtman et al. (2009).

The presently disclosed subject matter provides, in some aspects, compositions (e.g., ink compositions) for additive manufacturing (e.g., DIW processes) that include fumed alumina (e.g., hydrophobic fumed alumina). In some embodiments described hereinbelow, ceramic microrods of varying diameters were printed using preceramic resin-based inks comprising FA and optionally additional fillers. The effects of deposition nozzle diameter and ink composition were characterized and analyzed with Weibull analysis. Porosity content was quantified through area analysis, and the strength of individual microrods is measured with 3-point bend testing.

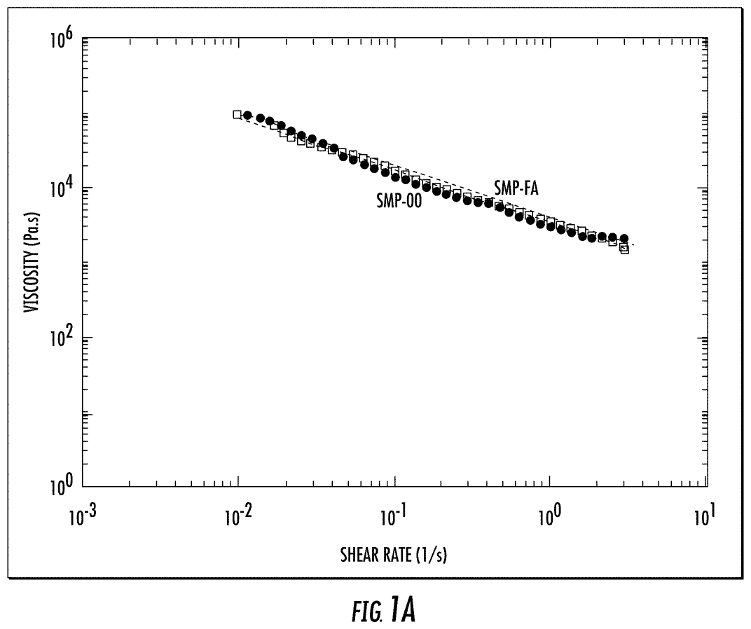

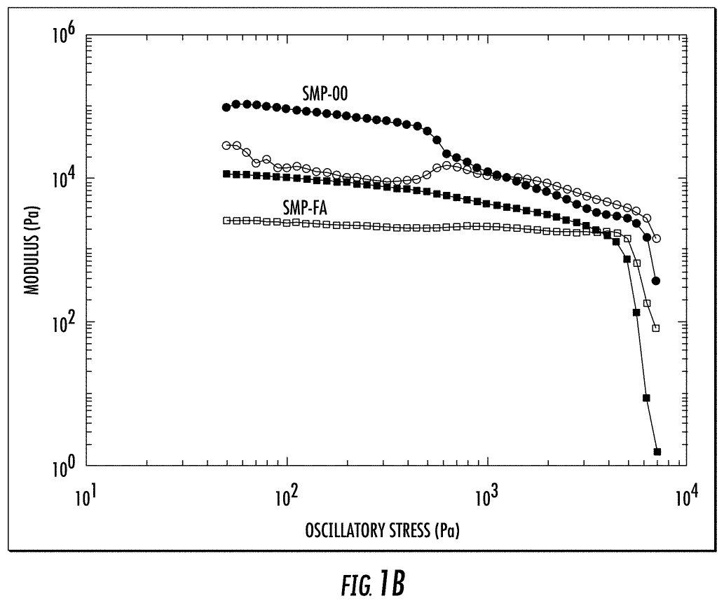

According to an aspect of the presently disclosed subject matter, the inclusion of the FA as a viscosifier/rheology modifier in the presently disclosed inks can impart excellent printing behavior to the preceramic resins. For example, inclusion of FA provides a more constant storage modulus below yielding and a more abrupt decrease in storage modulus at the point of yielding. See FIG. 1B. In addition, alumina has much better properties at high temperature compared to fumed silica or nanoclay, which are the other viscosifier/rheology modifiers typically used in thermoset inks for 3D printing.

Accordingly, in some embodiments, the presently disclosed subject matter provides a composition, e.g., an ink composition (such as an ink composition for use in additive manufacturing, such as DIW additive manufacturing) comprising a preceramic resin and FA. The FA can act as a rheology modifier. Thus, in some aspects, the presently disclosed subject matter relates to a method of modifying the rheology of a preceramic resin by adding FA to the resin. In some embodiments, the FA can be in the form of nanoparticles having an average diameter of about 10 nm to about 1000 nm (e.g., about 10 nm, 25 nm, 50 nm, 75 nm, 100 nm, 250 nm, 500 nm, 750 nm or about 1000 nm). In some embodiments, the FA comprises FA particles having an average diameter of about 10 nm to about 100 nm (e.g., about 10 nm, 20 nm, 30 nm, 40 nm, 50 nm, 60 nm, 70 nm, 80 nm, 90 nm, or about 100 nm). The compositions can provide for the creation of ceramics and ceramic composites with complex geometries. In some embodiments, the compositions can provide minimal shrinkage of during pyrolysis. Materials printed from the FA-containing compositions displayed lower porosity compared to comparable compositions without FA, both after curing and after pyrolysis. The lower porosity can provide better strength and an ability to create larger articles without cracking.

FA is a type of synthetic alumina. As a synthetic alumina, the FA of the presently disclosed subject matter has a high degree of chemical purity and a high specific surface area. In some embodiments, the FA can be prepared by flame hydrolysis processes known in the art. The flame hydrolysis processes for preparing the FA can be controlled by varying the concentration of the reactants, the flame temperature, and certain dwell times. These parameters can affect the particle size, particle size distribution, specific surface area, and the surface properties of the FA products.

FA particles prepared by flame hydrolysis processes are generally hydrophilic unless specifically treated. To form hydrophobic FA particles, the hydrophilic FA particles are subjected to chemical post-treatment with a hydrophobic agent. Suitable hydrophobic agents include, but are not limited to, organosilane compounds, such as alkoxysilanes, silazanes, and siloxanes. The terms “hydrophobic-treated FA”, “hydrophobized FA” and “hydrophobic FA” as used herein refer to FA in particle form, with a hydrophobic agent bonded to the particle surface by way of one or more oxygen covalent bonds.

Non-limiting examples of hydrophilic FA are those available as under the tradename AEROXIDE® Alu 65 and Alu 130 from Evonik Industries (Essen, Germany). Non-limiting examples of hydrophobic-treated FA are those available under the tradename AEROXIDE® Alu C from Evonik Industries (Essen, Germany).

In some embodiments, the FA of the presently disclosed compositions (e.g., ink compositions) comprises a hydrophobized FA. In some embodiments, the FA is hydrophobized with an organosilane (e.g., trimethoxysilane). In some embodiments, the FA is a blend of a hydrophilic FA and a hydrophobized FA. In some embodiments, the FA is a blend of two or more different hydrophobized FA.

In some embodiments, the FA has a specific surface area (BET) from greater than about 50 m²/g to less than about 200 m²/g. In certain embodiments, the FA has a specific surface area (BET) from about 55 m²/g to about 150 m²/g, or from about 60 m²/g to about 140 m²/g, or from about 65 m²/g to about 130 m²/g, or from about 75 m²/g to about 105 m²/g.

In some embodiments, the composition (e.g., the ink composition) comprises one or more additional rheology modifier (i.e., in addition to the FA). In some embodiments, the one or more additional rheology modifier is selected from a fumed silica, graphene, and a nanoclay. In some embodiments, the composition does not include a rheology modifier other than the FA.

The terms “preceramic polymer” and “preceramic resin” as used herein refer to a class of organo-silicon polymers that, when cured and pyrolyzed at high temperature, convert to an amorphous ceramic material. For example, pyrolysis can be performed at a temperature of about 800° C. to about 1600° C. (e.g., about 1000° C. or about 1200° C.). The polymer derived ceramics (PDCs) are of interest for use in extreme environments because the initial polymers can be shaped into complex structures and then converted to ceramic. During the conversion process, mass loss and shrinkage can occur. The mass loss amount can be represented as a percentage of initial polymer mass, called ceramic yield.

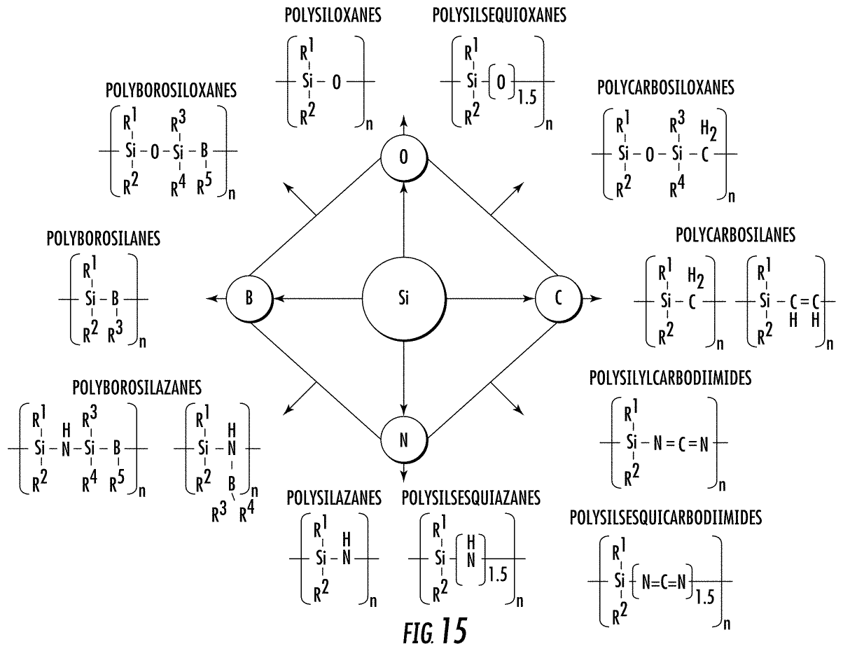

Preceramic polymers can be further classified based upon the type of atoms present in the polymer backbone, e.g., Si and B, Si and C, Si and N, Si and O, just Si, or other combinations of Si, B, C, N, and O. Various substituents can also be present attached to the Si or other atom (B, C, or N) in the backbone, e.g., H, alkyl, aryl, alkenyl, or other groups. Classes of preceramic polymers include polyborosilanes, polycarbosilanes, polysilazanes, polysilsesquizanes, polysiloxanes, polysilsequioxanes, and polysilanes. Formulas of various classes of preceramic polymers are shown in FIG. 15.

In some embodiments, the preceramic resin comprises one or more resin selected from the group comprising a polyborosilane, a polyborosilazane, a polyborosiloxane, a polycarbosilane, a polycarbosiloxane, a polysilazane, a polysilsesquizane, a polysiloxane, a polysilsequioxane, a polysilylcarbodiimide, a polysilsesquicarbodiimide, a polysilane, and blends thereof. In some embodiments, the preceramic resin comprises one or more resin selected from the group comprising a polyborosilane, a polycarbosilane, a polysilazane, a polysilsesquizane, a polysiloxane, a polysilsequioxane, a polysilane, and blends thereof. In some embodiments, the preceramic resin comprises a polycarbosilane resin or a polysilazane resin. In some embodiments, the preceramic resin comprises a blend or mixture of more than one polycarbosilane resin or a blend or mixture of more than one polysilazane resin.

In addition to the preceramic resin and fumed alumina, the presently disclosed compositions can optionally include one or more filler(s) such as, but not limited to, one or more of fillers comprising (e.g., each comprising) a composition selected from zirconia, alumina, silicon carbide (e.g., silicon carbide nanoparticles, fibers, and/or whiskers), silicon nitride, aluminum nitride, boron nitride, titanium diboride, boron carbide, titanium carbide, carbon (e.g., carbon fibers), an oxide (e.g., an oxide fiber), and zirconium diboride. For example, the one or more fillers can include two or more fillers, each of which has a composition selected from the group comprising zirconia, alumina, silicon carbide, silicon nitride, aluminum nitride, boron nitride, titanium diboride, boron carbide, titanium carbide, carbon, an oxide, and zirconium diboride. The filler(s) can be provided as nano- and/or microparticles (including as fibers or whiskers with at least one micro- or nanoscale dimension). In some embodiments, the filler(s) is/are selected from whiskers, e.g., silicon carbide whiskers, and/or particles, e.g., zirconium diboride nano- or microparticles. In some embodiments, the whiskers, e.g., silicon carbide whiskers, can have an average length of about 10 microns to about 500 microns and an average diameter of about 0.5 micron to about 1 micron.

In some embodiments, the composition (e.g., ink composition) comprises about 40 percent by volume (vol %) to about 97 vol % preceramic resin (e.g., about 40 vol %, about 45 vol %, about 50 vol %, about 55 vol %, about 60 vol %, about 65 vol %, about 70 vol %, about 75 vol %, about 80 vol %, about 85 vol %, about 90 vol %, about 95 vol % or about 97 vol % preceramic resin). In some embodiments, the composition comprises about 50 vol % to about 75 vol % preceramic resin.

In some embodiments, the composition (e.g., ink composition) comprises about 3 vol % to about 25 vol % FA (e.g., about 3, 5, 7, 9, 11, 13, 15, 17, 19, 21, 23, or 25 vol % FA). In some embodiments, the composition comprises about 4 vol % to about 17 vol % fumed alumina.

In some embodiments, the composition (e.g., ink composition) comprises about 50 vol % to about 70 vol % preceramic resin, about 4 vol % to about 20 vol % FA, and about 15 vol % to about 60 vol % filler(s) (e.g., about 15 vol %, about 20 vol %, about 25 vol %, about 30 vol %, about 35 vol %, about 40 vol %, about 45 vol %, about 50 vol %, about 55 vol % or about 60 vol % of one or more fillers). For example, in some embodiments, the composition comprises about 50 vol % to about 60 vol % polycarbosilane resin, about 4 vol % to about 10 vol % FA, and about 35 vol % to about 45 vol % ZrB₂ filler (ZrB₂ micro- or nanoparticles). In some embodiments, the composition comprises about 51.7 vol % polycarbosilane resin; about 5.95 vol % FA; and about 42.4 vol % ZrBr₂ filler.

In some embodiments, the composition comprises about 60 vol % to about 70 vol % polycarbosilane resin, about 12 to about 17 vol % FA, and about 15 vol % to about 23 vol % silicon carbide whiskers. In some embodiments, the composition comprises about 66.7 vol % polycarbosilane resin; about 16.45 vol % FA; and about 16.8 vol % silicon carbide whiskers.

In some embodiments, the composition comprises about 60 vol % to about 70 vol % polysilazane resin, about 12 vol % to about 17 vol % FA, and about 15 vol % to about 23 vol % silicon carbide whiskers. In some embodiments, the composition comprises about 66.1 vol % polysilazane resin; about 16.8 vol % FA; and about 17.1 vol % silicon carbide whiskers.

In some embodiments, the presently disclosed composition (e.g., ink composition) has a lower storage modulus and/or a higher yield stress than a composition comprising the same resin (or same resin and same optional filler(s)) but not comprising FA. In some embodiments, the presently disclosed composition has a more constant storage modulus prior to yield than a composition comprising the same resin (or same resin and optional filler(s)) but not comprising FA. Thus, in some embodiments, the storage modulus below yield varies by a smaller amount than the storage modulus below yield for a composition comprising the same resin and optional filler(s). In some embodiments, the presently disclosed composition has a transition (a decrease in storage modulus) at yielding that is more abrupt than a composition comprising the same resin (or same resin and optional filler(s)) but not comprising FA.

In some embodiments, the presently disclosed subject matter provides a method of making a ceramic object, e.g., a silicon carbonitride or a silicon carbide object. In some embodiments, the method comprises: (a) printing (or extruding or otherwise depositing) a composition as described herein (i.e., a composition (e.g., an ink composition) comprising a preceramic resin, FA (e.g., a hydrophobic FA), and optionally a filler or fillers (e.g., thus providing a “green” object), and (b) curing and pyrolyzing the composition to provide the ceramic object. The “printing” can refer to depositing a thin line or “bead” of the composition (e.g., the ink composition) using a print head, which can include an extruder (e.g., a syringe) filled with the composition attached to a nozzle. In some embodiments, the printing is controlled by a computer (e.g., the print head can be mounted on a computer numeric controlled (CNC) machine with controlled motion along at least the x-, y- and z-axes). The thin line can have any desired length and width and can form any desired shape. In some embodiments, the thin line can have a width of about 10 mm or less (e.g., about 5 mm, 1 mm, 0.9 mm, 0.8 mm, 0.7 mm, 0.6 mm, or 0.5 mm or less).

In some embodiments, the method comprises printing a first layer of the composition (e.g., the ink composition) and one or more successive additional layers of the composition (e.g., the ink composition) wherein each of the one or more additional layers of the composition is printed on a surface of at least a portion of a previously printed layer. In some embodiments, the method comprises printing layers of at least two different compositions (e.g., at least two different ink compositions), wherein the different compositions can include different resins, FAs, or fillers and/or different ratios of resin, FA, and filler(s) (e.g., a different ratio of the same resin, FA and fillers as another one of the different compositions used).

Curing and pyrolyzing can be performed using any suitable processes known in the art for curing and pyrolyzing preceramic resins. Methods of curing and pyrolyzing preceramic ink are described, for example, in Colombo et al. (2010). In some embodiments, the curing is performed by heating the printed composition to a temperature of about 100° C. to about 300° C. In some embodiments, the curing is performed by heating the printed composition to a temperature of about 160° C. to about 250° C. In some embodiments, the curing is performed at a temperature between about 200° C. and about 230° C. In some embodiments, the curing is performed in air. In some embodiments, the pyrolyzing is performed by heating the cured object to a temperature of about 800° C. to about 1600° C. In some embodiments, the pyrolyzing is performed by heating the cured object to a temperature of at least about 1000° C. (e.g., a temperature of about 1000° C. to about 1200° C.).

In some embodiments, the presently disclosed subject matter provides a three-dimensional object comprising a composition as described herein (e.g., a composition comprising a preceramic resin and FA (e.g., a hydrophobic FA)). The object can include a plurality of layers of the same composition or layers of different compositions comprising preceramic resin and FA. In some embodiments, the presently disclosed subject matter provides a ceramic object prepared by pyrolyzing an ink composition as described herein or by curing and pyrolyzing an ink composition as described herein. In some embodiments, the object is prepared by printing or extruding an ink composition and curing and pyrolyzing the printed composition.

Thus, in some embodiments, the presently disclosed subject matter provides a ceramic object comprising a pyrolyzed composition as disclosed herein, i.e., the material resulting from the pyrolysis of a composition comprising a preceramic resin and FA (e.g., a hydrophobic FA) and optionally further including one or more fillers. The object can have any desired shape and size. In some embodiments, the object is a 3D printed object or an object with complex geometry. In some embodiments, the ceramic object has a higher flexural strength and/or Weibull modulus than a ceramic object of the same size prepared from an ink composition not including fumed alumina. In some embodiments, a large size ceramic object can be provided by use of the presently disclosed compositions, i.e., in view of the lower porosity and cracking afforded by the presently disclosed compositions.

In some embodiments, the presently disclosed subject matter provides a ceramic object comprising a ceramic matrix and FA (e.g., a hydrophobic FA). In some embodiments, the ceramic matrix comprises a silicon carbide matrix or a silicon carbonitride matrix and FA (e.g., hydrophobic FA) embedded therein. In some embodiments, the ceramic object further comprises one or more fillers embedded in the matrix. In some embodiments, the one or more fillers comprises a material selected from the group comprising zirconia, alumina, silicon carbide (e.g., silicon carbide particles, whiskers or fibers), silicon nitride, aluminum nitride, boron nitride, titanium diboride, boron carbide, zirconium diboride (ZrB₂), carbon (e.g., carbon fibers), an oxide (e.g., oxide fibers), and titanium carbide. In some embodiments, the filler comprises or consists of ZrB₂ particles (e.g., micro- or nanoparticles) or silicon carbide whiskers.

In some embodiments, the ceramic object has improved porosity (e.g., smaller pores and/or fewer cracks) than an object of the same size prepared from an ink not including FA. In some embodiments, the ceramic object has a higher flexural strength and/or Weibull modulus than a ceramic object of the same size prepared from an ink composition not including FA.

For example, according to one aspect of the presently disclosed subject matter, microrods of varying sizes were fabricated via DIW, an AM technique, with two inks comprised of polycarbosilane (PCS), zirconium diboride (ZrB₂), and FA. Each microrod was about 25 mm in span length and nominally either 450, 634, 979, 1346, or 1702 μm in diameter. Failure strength was measured through 3-point flexural testing for microrods printed with each ink composition and nozzle size. For a given nozzle size, the microrods made with FA-containing ink possess higher strength than those without FA. Weibull strength analysis was performed on each group of microrods and shows that the addition of FA increases Weibull modulus from 4.63±1.56 to 9.35±0.601. In addition, microrods were fabricated via DIW using inks comprising PCS or polysilazane resins, FA, and silicon carbide whiskers.

### EXAMPLES

The following Examples have been included to provide guidance to one of ordinary skill in the art for practicing representative embodiments of the presently disclosed subject matter. In light of the present disclosure and the general level of skill in the art, those of skill can appreciate that the following Examples are intended to be exemplary only and that numerous changes, modifications, and alterations can be employed without departing from the scope of the presently disclosed subject matter.

### Example 1

### Polycarbosilane Inks with and without Fumed Alumina

SMP-10 (Starfire Systems Inc., Schenectady, N.Y., United States of America), an allylhydridopolycarbosilane, or simply polycarbosilane, was used as the base polymer resin. The PCS polymer has a polydispersity index of 5.544, thermally crosslinks without catalyst at 250° C., yields 72-78 wt. % amorphous SiC after pyrolysis, and begins to form SiC crystallites at 1250° C. See Apostolov et al. (2020); and Potticary (2017). Two inks were developed with SMP-10, one further containing ZrB₂ and FA, and the other only ZrB₂. These formulations are designated SMP-FA and SMP-00, respectively. See Table 1, below, summarizes the compositions of each ink.

The FA (sold under the tradename AEROXIDE® Alu C 805, Evonik Industries, Essen, Germany) and ZrB₂ (H. C. Stark GmbH, Grade B, Goslar, Germany) had average particle sizes of 13 nm and 3.6 μm, respectively. See Bera et al. (2013); and Kemp et al. (2021).

Both inks were mixed with a planetary mixer (FlackTek, Inc. Landrum, S.C., United States of America) in 98-mL plastic containers under vacuum of 100 mbar. ZrB₂ was added to the PCS polymer in two equal parts to reach the desired loading and was mixed at 1500 rpm for 2 min after each addition. For SMP-00, the sidewalls of the mixing cup were scraped down with an offset spatula and mixed once more at 1800 rpm for 2 min. FA was added to the SMP-FA ink in 3 equal increments followed by mixing for 2 min at 1800 rpm after each addition. The gradual introduction of ZrB₂ and FA aided in the mixing and incorporation of the ceramic powders into the PCS polymer.

TABLE 1
Ink compositions for SMP-00 and SMP-FA.

| | SMP-10 | ZrB₂ | Fumed Al₂O₃ |
|---|---|---|---|
| Ink Name | [vol. %] | [vol. %] | [vol. %] |
| SMP-00 | 52.5 | 47.5 | 0.00 |
| SMP-FA | 51.7 | 42.4 | 5.95 |

### Rheological Characterization:

The rheological properties of each ink were measured using a Discovery Hybrid Rheometer (DHR-2, TA Instruments, New Castle, Del., United States of America) using a 40 mm diameter, flat platen, and a Peltier base. Testing was performed at 25° C. with a gap size of 1 mm.

All tests included a 2 minute pre-conditioning step at a constant shear rate 0.1/s followed by a 2 min. rest to allow the material to equilibrate. Oscillatory stress sweeps were conducted between 50-7000 Pa for both inks. In addition, flow sweeps were measured over a range of 0.01-3 l/s for both inks.

### Printing and Pyrolysis:

Microrods were printed using five different nozzle sizes with diameters of 450, 634, 979, 1346, and 1702 μm. A custom DIW platform including a 3-axis gantry (ShopBot Tools, Inc., Durham, N.C., United States of America), solenoid valves, and a voltage-controlled air pressure regulator was used for deposition. Inks were manually loaded into 10 cc syringe barrels (Fisnar Inc., Wayne, N.J., United States of America) with a SpeedDisk (FlackTek, Inc. Landrum, S.C., United States of America), which reduced the amount of air in the syringe. Syringes were loaded into a HP-10 cc air pressure adapter (Nordson EFD., Westlake, Ohio, United States of America) then mounted to the gantry system. The print head was raised to a height of 0.75 times the nozzle diameter above the substrate. Microrods 32 mm in length were printed on glass slides coated with a PTFE-coated aluminum foil (Bytac, Saint-Gobain Performance Plastics, Worcester, Mass., United States of America). Custom print paths for the microrods were made from g-code scripts written in Scilab open-source software (ESI Group, France). For all nozzles used, a print speed of 20 mm/s was specified. A summary of the pressures for each combination of ink and nozzle size is shown in Table 2, below.

Printed samples were cured in air with a two-stage process. The first stage was a ramp-up to 167° C. at 1° C./min, hold for 1 hr., then back down to room temperature. The second stage was a ramp-up to 230° C. at 1° C./min, hold for 1 hr., then back down to room temperature. The two-stage curing cycle was used to prevent the adhesive backing in the Bytac film from degrading and affecting curing. Additionally, curing in air introduced oxygen into the final cross-linked polymer and can cause oxides to form after ceramic conversion. Pyrolysis was performed in a tube furnace (CM Furnaces Inc., 1830-10 VF, Bloomfield, N.J., United States of America) with flowing argon at a rate of 5.2 liters per min (lpm). The pyrolysis schedule was as follows: 1° C./min to 1200° C. with 1 h holds at 300° C., 450° C., and 600° C. and 2 h holds at 800° C. and 1200° C. on the ramp-up, then cooled to room temperature at 5° C./min. Both curing and pyrolysis schedules were based upon previous thermal treatments of the PCS polymer. See Apostolov et al. (2020); and Key et al. (2018).

TABLE 2
Summary of pressures used for inks with varying nozzle sizes.

| Nozzle Diameter | SMP-00 pressure | SMP-FA pressure |
|---|---|---|
| [μm] | [kPa, psi] | [kPa, psi] |
| 450 | 2758, 400 | 2758, 400 |
| 634 | 2068, 300 | 1793, 260 |
| 979 | 1931, 280 | 1379, 200 |
| 346 | 1655, 240 | 1048, 152 |
| 702 | 1379, 200 | 1048, 152 |

Thermogravimetric analysis (TGA) and differential scanning calorimetry (DSC) of uncured inks were performed on a Q500 TGA (TA Instruments, New Castle, Del., United States of America) and Q60 DSC (TA Instruments, New Castle, Del., United States of America) instrument, respectively. In addition, TGA and DSC of cured material were performed on a simultaneous thermal analyzer (SDT) Q600 (TA Instruments, New Castle, Del., United States of America).

Flexural properties of pyrolyzed microrods were measured on the same Discovery Hybrid rheometer that performed the parallel plate rheometry, but with a 3 point bend fixture. A span of 25 mm and a crosshead speed of 0.01 mm/s were used. Vickers microhardness testing was conducted on polished cross-sections of printed, pyrolyzed bars using a Wilson VH1202 microhardness tester (Buehler, LakeBluff, Ill., United States of America) with a 0.2 kg load and 10 s dwell.

### Imaging and Analysis:

Optical images of fracture surfaces of the microrods and porosity area percentage measurements on the bottom surface of fractured microrods were taken with a VHX-5000 digital microscope (Keyence, Itasca, Ill., United States of America). The second moment of area about the x-axis, Ix, of fracture surfaces was calculated by using a plug-in for the open-source software, Image J (National Institute of Health, Madison, Wis., United States of America) called MomentMacro (John Hopkins School of Medicine, Baltimore, Md., United States of America). Weibull analysis of fracture strength was performed with custom scripts in MATLAB software (Mathworks, Natick, Mass., United States of America), and Weibull moduli were found by performing a least-squares fit. SEM micrographs of gold sputter-coated flexural fracture surfaces were taken using an Auriga Crossbeam FIB/SEM (Zeiss Group, United States of America).

DIW inks characteristically exhibit a high degree of shear-thinning, yield stress behavior (τy, ≥200 Pa), and an equilibrium storage modulus (G′0, ≥10⁴ Pa). See Smay et al. (2002); Lewis (2000); Hmeidat et al. (20180; Romberg et al. (2021); Lewis et al. (2006); Compton et al. (2018); Conrad et al. (2011); Therriault et al. (2007); and Zhu and Smay (2012). High Ty indicates that a layer of ink can support the weight of subsequent layers (see Hmeidat et al. (2018); and Romberg et al. (2021)), while sufficiently high G′0 indicates an ink can withstand buckling and support its own weight over spanning features with minimal elastic deformation. See Hmeidat et al. (2018); Romberg et al. (2021); and Zhu and Smay (2012). The rheological behavior of each ink is shown in FIGS. 1A and 1B. The rheological properties of the base PCS resin are characterized elsewhere. See Apostolov et al. (2020); and Kemp et al. (2021). The viscosity profile of both inks is shown in FIG. 1A. Here, the equation:

η=K\dot{γ}ⁿ⁻¹

where η is the apparent viscosity, K is the consistency index, γ is the shear rate, and n is the flow index is fit to the apparent viscosity measurements using linear regression and used to find K and n for each ink. The value of n characterizes the nature of the fluid, where n<1, =1, and >1 represent a shear-thinning fluid, a Newtonian fluid, and a shear-thickening fluid, respectively. The fitted values and their goodness of fit are shown in Table 3, below. Both inks have nearly identical viscosity profiles over the range of shear rates probed.

TABLE 3
Rheological properties of DIW inks

| | G′0 | τy | | K | |
|---|---|---|---|---|---|
| Ink Name | [kPa] | [Pa] | n | [Pa · s] | R² |
| SMP-00 | 84.6 | 1119 | 0.28 | 3285 | 0.988 |
| SMP-FA | 9.58 | 3760 | 0.29 | 3491 | 0.982 |

Both G′ and G″ for both inks are shown in FIG. 1B. For the majority of the stress range probed, the storage modulus is larger than the loss modulus, indicating nominally elastic solid-like behavior. With increasing stress, the particle network in each ink breaks down and G′ decreases until it is surpassed by G″. The Ty, described as the break-down point of the particle network, can be defined in several ways (see Dinkgreve et al. (2016)), is defined herein as shear stress at which G″ exceeds G′.

With the addition of FA, a decrease in G′ 0 and an increase in Ty are observed. Fumed oxide materials, like the FA used in this study, can induce shear-thinning behavior by forming networks of interconnected oxide colloidal aggregates. See Zocca et al. (2016); Zhu et al. (2020); and Raghavan et al. (1995). Without being bound to any one theory, it is believed that the reduced G′0 value for SMP-FA compared to SMP-00 can be explained by the reduced volume fraction of ZrB₂ in the SMP-FA ink, or as an effect of the fumed alumina or some interaction between the FA and ZrB₂. Fumed alumina has not been used as a viscosifier in preceramic polymer inks before.

### Thermal Behavior

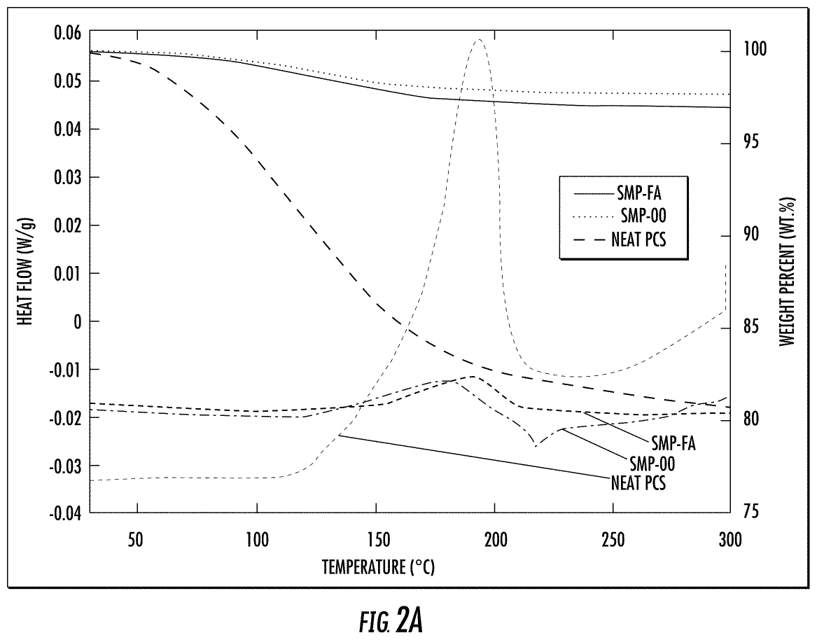

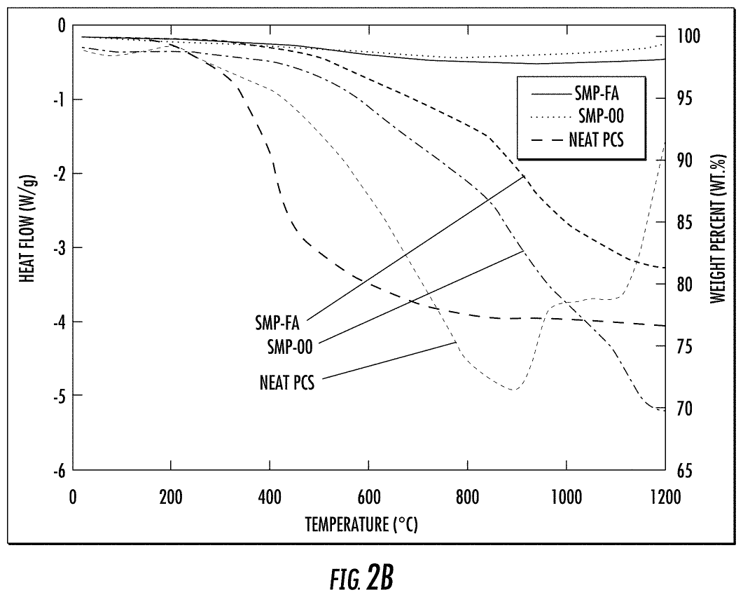

TGA and DSC curves for both uncured inks up to 300° C. and cured inks up to 1200° C. are shown in FIGS. 2A and 2B, respectively. For both the uncured SMP-00 and SMP-FA inks, mass loss begins at the onset of heating and proceeds at a constant rate until approximately 170° C. (see FIG. 2A), where the loss rate slows. DSC curves indicate that crosslinking initiates at ˜120° C., with a peak exotherm between 170° C. and 200° C., roughly corresponding to the reduction in the mass loss rate observed with TGA. During the initial ramp-up in temperature, the PCS present in each ink begins to off-gas low molecular weight oligomers, shown by mass loss up to 170° C. Interestingly, the SMP-00 differs from SMP-FA in that it has an endothermic reaction occurring at 210° C. that also corresponds to a small mass loss event. At present, it is unclear what causes this event, but it is not observed in the PCS alone or the SMP-FA ink. Mass-spectrometry and gas chromatography measurements during a similar heat ramp can be used to help identify a difference in the composition of the gases evolving from each ink during curing and pyrolysis. See Campbell et al. (2020).

During pyrolysis (see FIG. 2B), both cured SMP-00 and SMP-FA samples show only ˜1-2 wt. % total mass loss, while the neat PCS exhibits 24% total mass loss. All three cured materials have an initial mass loss event that begins at 200° C. and ends at 400° C., with another event beginning at around 800° C. The large amount of inert ceramic filler content dominated the mass loss curves for the two inks.

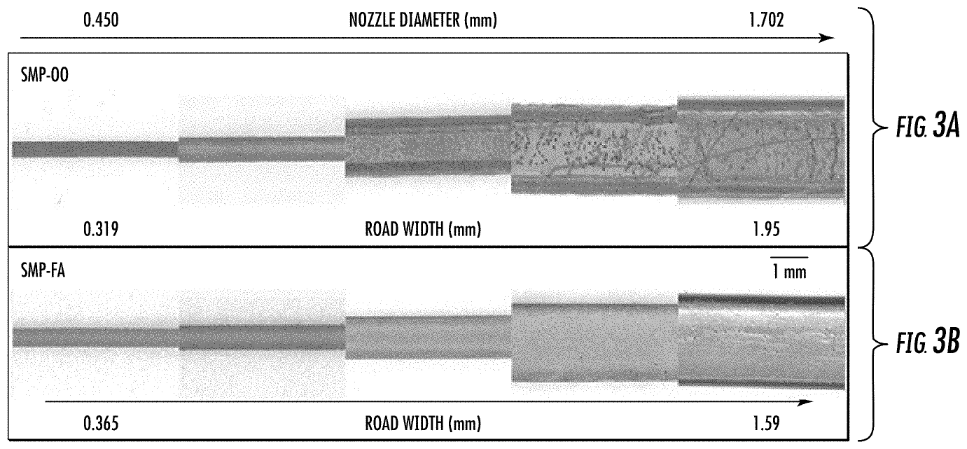

FIGS. 3A and 3B depict representative regions of the bottom surface of microrods printed with 5 different nozzle diameters after curing. The surfaces were directly in contact with the PTFE-coated substrate. Looking at SMP-00 rods in FIG. 3A and moving from left to right, bubbles are not present in the smallest rod (nozzle diameter=450 μm, width=0.319 mm) but become prevalent as nozzle size increases. Additionally, as nozzle size increases, bubble size appears to increase. Large crack-like features form on the surface of the largest printed rods. For the SMP-FA rods in FIG. 3B, bubbles are observed in all rods except the smallest nozzle diameter size. In contrast to SMP-00, bubbles observed in the SMP-FA rods appear to be more consistent in size and distribution in the middle three nozzle sizes until reaching the largest nozzle size (1702 μm), where bubble size increases considerably.

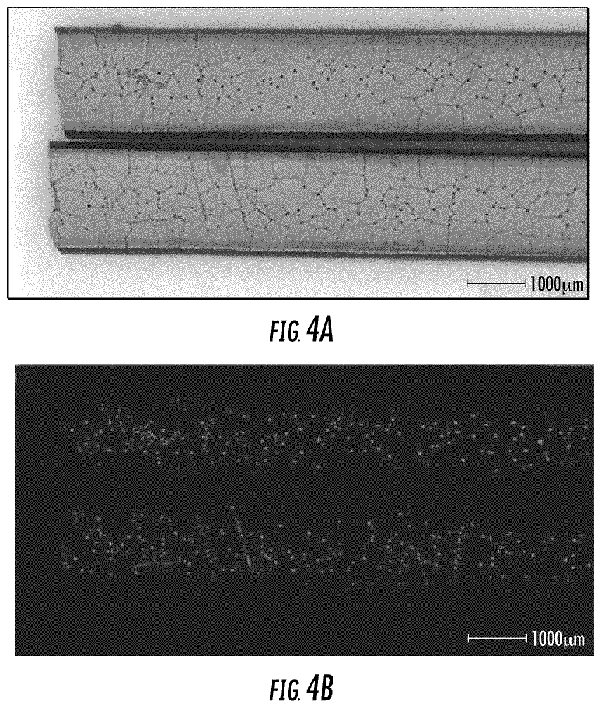

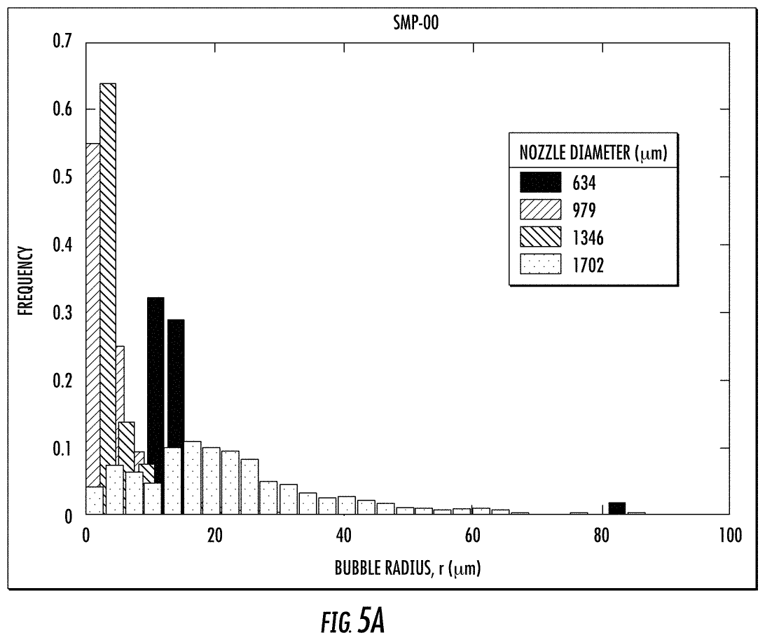

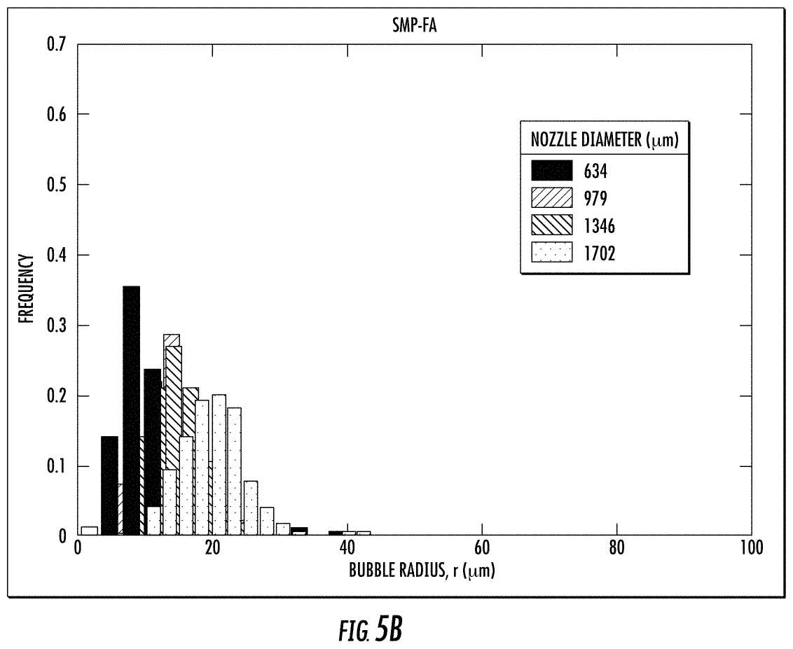

To quantify the area of porosity on the bottom surface of printed and pyrolyzed microrods, optical analysis was performed utilizing the built-in area analysis software of a Keyence microscope (Keyence, Itasca, Ill., United States of America). An example of the bubbles and the corresponding binary image is shown in FIGS. 4A and 4B. Histograms of effective bubble radius, r, for each nozzle diameter for both SMP-00 and SMP-FA are shown in FIGS. 5A and 5B, where r=√(Ab/π), and Ab is the area of a bubble. A bin size of 3 μm was used for the histograms. The smallest nozzle size, 450 μm, is not shown because no bubbles were observed at 1000 times magnification for both inks. For SMP-00 (see FIG. 5A), the three smallest nozzle sizes have a higher number of smaller bubbles. For SMP-FA (see FIG. 5B), with increasing nozzle size, r also tends to increase.

Table 4, below, displays the total area of porosity measured on each specimen along with the number-average and mode r. The smallest printed rod has an average bubble size much larger than both the 979 and 1346 μm nozzles for the SMP-00 ink but has a much larger standard deviation. This indicates there are both very large and small bubbles present in the smallest nozzle size. For the largest nozzle size of 1702 μm, the SMP-00 has a large standard deviation in r. For SMP-FA, r increases in size from 26 μm to 35 μm between 1346 and 1702 μm nozzles. An additional measurement of the percentage of the area imaged (just the bottom surface) is shown in the final column of Table 4. The area percentage is just of the surface imaged and is not representative of the total volume of the microrod. This percentage, in tandem with the bubble size, shows that for both materials, the increase in bubble size for both inks is detrimental to the strength of the larger microrods and indicates that with increasing nozzle size, flaw distribution changes.

The bubbles in FIGS. 3A and 3B are believed to be caused by the off-gassing of oligomers and other hydrocarbon materials from the PCS polymer during curing, as in prior preceramic inks (see Apostolov et al. (2020); and Kemp et al. (2021)), and as indicated in the TGA analysis. See FIGS. 2A and 2B.

TABLE 4
The measured area of all specimens
used for porosity area calculation.

| | | | | | |
|---|---|---|---|---|---|
| | | | | | Percent- |
| | | | Average | Mode | age of |
| | | | effec- | effec- | measured |
| | Number | Total | tive | tive | area |
| Nozzle | of bubbles | Area | bubble | bubble | that is |
| diameter | measured, | measured | radius, | radius, | bubbles |
| [μm] | N | [μm²] | r [μm] | r[μm] | [%] |

SMP-00

| | | | | | |
|---|---|---|---|---|---|
| 634 | 62 | 2589.9 | 11.3 ± 10.5 | 1.38 | 1.78 |
| 979 | 17417 | 8920.9 | 4.36 ± 3.77 | 1.78 | 20.4 |
| 1346 | 12291 | 21790.7 | 6.17 ± 6.45 | 2.32 | 14.1 |
| 1702 | 1595 | 26818.2 | 23.2 ± 17.3 | 0.977 | 15.6 |

SMP-FA

| | | | | | |
|---|---|---|---|---|---|
| 634 | 1496 | 5648.4 | 10.8 ± 5.89 | 5.56 | 12.5 |
| 979 | 2190 | 11050.3 | 13.5 ± 4.77 | 5.89 | 12.8 |
| 1346 | 3203 | 20253.6 | 14.7 ± 3.95 | 8.23 | 11.5 |
| 1702 | 425 | 30270.6 | 20.0 ± 4.84 | 11.5 | 1.88 |

The greater size of bubbles and the presence of a crack-like structure for the SMP-00 rods suggests that FA addition in the SMP-FA can aided in the diffusion process. FA is thought to aid in the gas diffusion of low-molecular-weight oligomers, whereas ZrB₂ alone can cause entrapment of gases. Because of the spheroidal shape of the ZrB₂ particles, gaps can occur between individual particles. These gaps can be places where gases collect during off-gassing and that lead to eventual porosity.

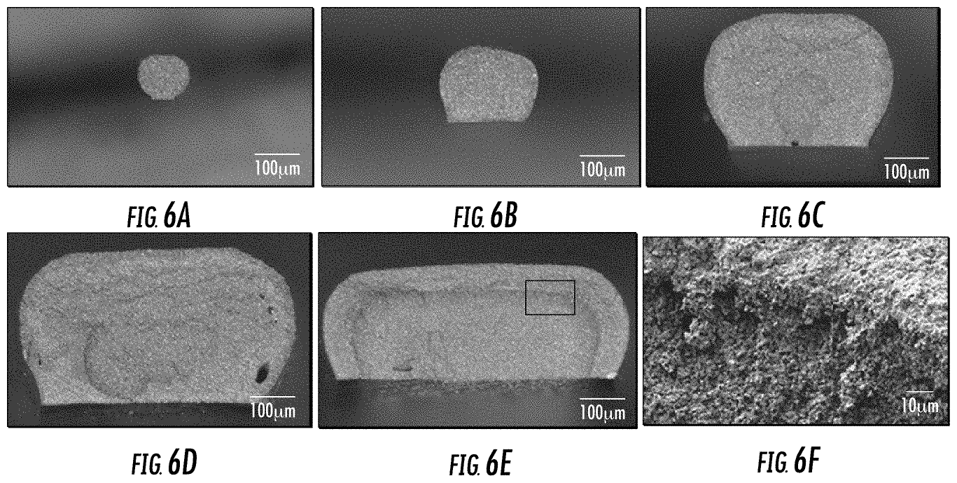

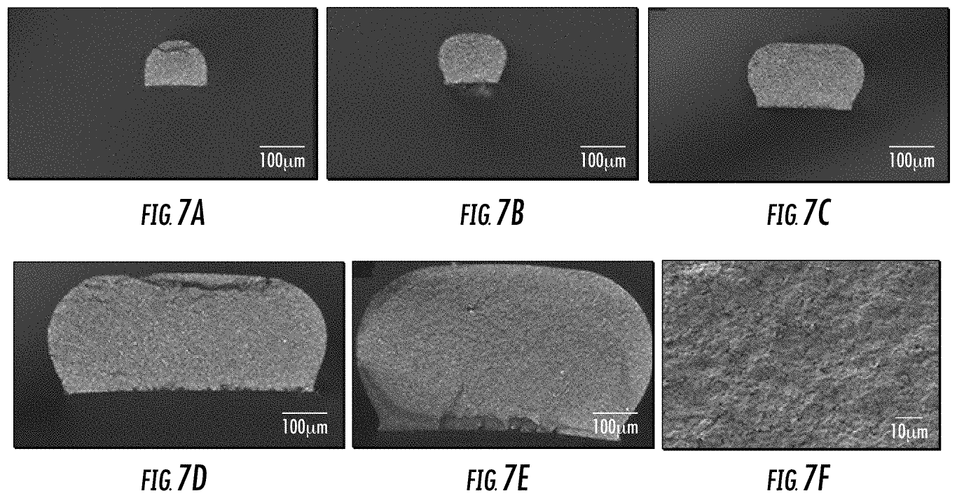

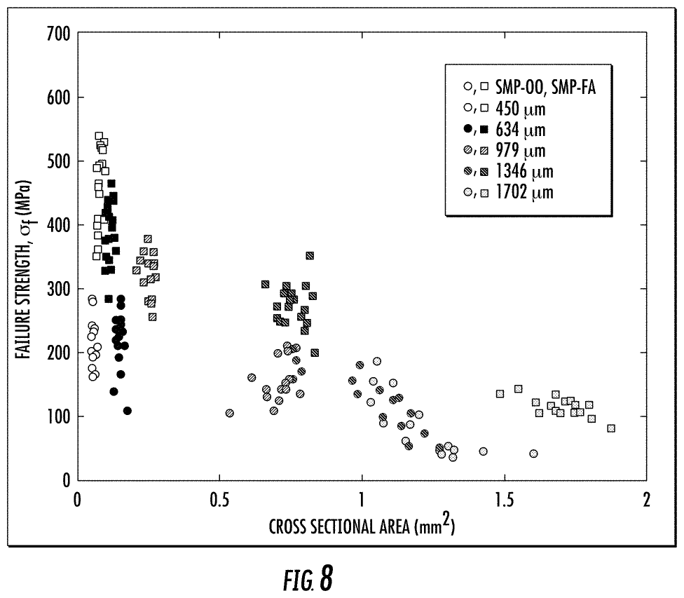

32-mm-length microrods printed with 450, 634, 979, 1346, and 1702 μm-diameter nozzles were pyrolyzed and tested in 3-point flexure. Optical micrographs of the overall fracture surface of each microrod are shown in FIGS. 6A-6F and FIGS. 7A-7F for SMP-00 and SMP-FA, respectively. For the SMP-00 samples in FIGS. 6A-6F, a noticeable boundary in the center of the fracture surface develops in the larger rods. SEM along this boundary in the sample printed using the 1702-μm-diameter nozzle (see FIG. 6E) is shown in FIG. 6F. A significant difference in contrast between the inner and outer surfaces can be seen, where the darker, inner region appears to be more porous when compared to the outer, lighter region. Without being bound to any one theory, this observation is believed to be the result of how gas diffuses in the specimens, where gas pressure in the center of the specimens can lead to a higher concentration of PCS polymer near the outer boundaries of the rods. An additional reason for this boundary structure can be due to the deposition process, where higher shear rates at the nozzle wall can lead to a higher concentration of polymer. See Kanarska et al. (2019). However, because the boundary feature is not observed on the bottom surfaces of the rods, where the major porosity forms, it appears more likely that the feature is related to off-gassing during curing.

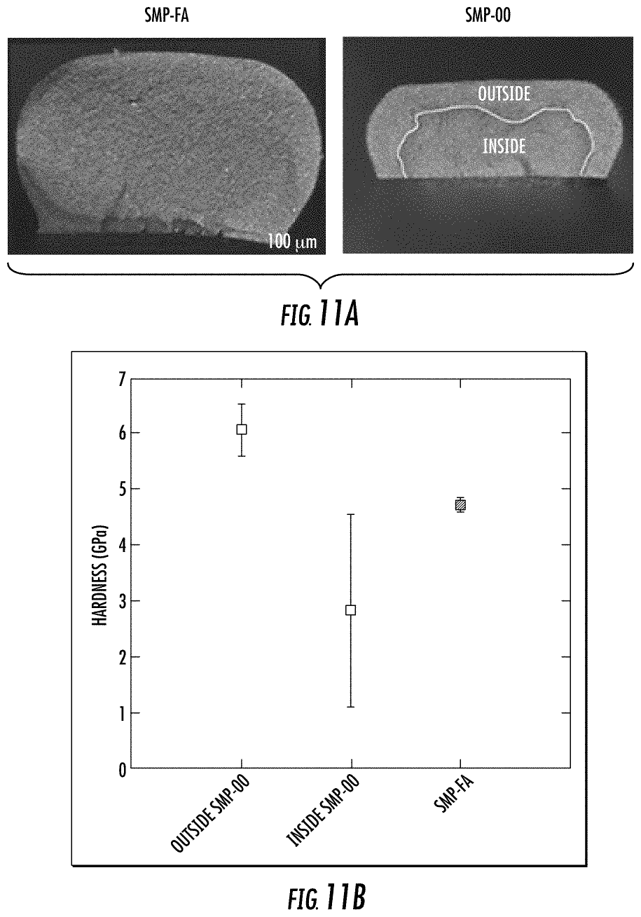

Alternatively, for the SMP-FA samples (see FIGS. 7A-7F), no circular internal boundary is apparent, and all fracture surfaces appear smoother and more uniform than those of the SMP-00. See FIG. 7F. Vickers microhardness indentations on polished cross-sections from the rods printed using the 1702-μm diameter reveal differences between the two different regions in the SMP-00. See FIG. 11A. The inner region of the SMP-00 rods has a Vickers hardness of 2.84±1.7 GPa, while the outer region has a Vickers hardness of 6.05±0.45 GPa. See FIG. 11B. The SMP-FA rod has a Vickers hardness value of 4.71±0.11 GPa. See FIGS. 11A and 11B. The fact that the inner region of the SMP-00 samples had the lowest hardness is consistent with the hypothesis that gas evolution during curing leads to a lower concentration of PCS polymer in the central region of the printed samples, as discussed above. If desired, compositional differences between the inner and outer regions of the SMP-00 samples can be further explored using techniques such as energy-dispersive X-ray spectroscopy.

The measured cross-sectional area, Ac, of the fracture surface of a microrod with respect to the measured failure strength, σ_{f} of each microrod, is shown in FIG. 8. The σ_{f} for each microrod was calculated by using the classic bending formula:

$${σ}_{f} = \frac{Mc}{{I}_{x}}$$

where c is the distance from the centroid to the bottom surface of the microrod, Ix is the calculated Ix from ImageJ, and M is the bending moment. The printed microrods were loaded in 3-pt. flexure, so that the maximum moment in the rod is M=PL/4 (where L is the span length of the microrod and F is the force applied to the rod at failure). Thus, when the specimen is a rod:

$${σ}_{f} = \frac{{FL}_{c}}{4 {I}_{x}}$$

where Ac was measured and Ix was calculated using the open-source macro, MomentMacro, for ImageJ. The tool calculates Ix following much of the work described by Medalia. See Medalia (1971). By plotting Ac against σ_{f}, two major conclusions can be drawn from FIG. 8: i) strength is inversely related to cross-sectional area, and ii) SMP-FA is generally stronger than SMP-00. The decrease in strength is correlated with the presence, size, and amount of porosity observed on the bottom surfaces of the printed rods (see FIGS. 4A and 6F) and will be analyzed in greater depth in the following section.

Weakest link theory states that the survival probability of a brittle solid depends on sample volume and flaw distribution. See Zok (2017). Flaws within a sample ultimately dictate strength, meaning that larger volumes of material have a greater likelihood of failure because of the increased chance of a failure initiating flaw being present in the sample. See Quinn and Quinn (2010); and Zok (2017). Weibull suggested that a two-parameter fit can be used to interpret the probability of failure of brittle ceramics as a function of failure strength with the following equation:

$${P}_{f} = 1 - exp ( - {( \frac{{σ}_{f}}{{σ}_{c}} )}^{m} )$$

where P_{f} is the probability of failure, m is the Weibull modulus, and σ_{c} is some characteristic strength of tested specimens. See Wachtman et al. (2009). This equation can be rearranged for better interpretation into the following form:

$$ln ln ( \frac{1}{1 - {P}_{f}} ) = m ln {σ}_{f} - m ln {σ}_{c}$$

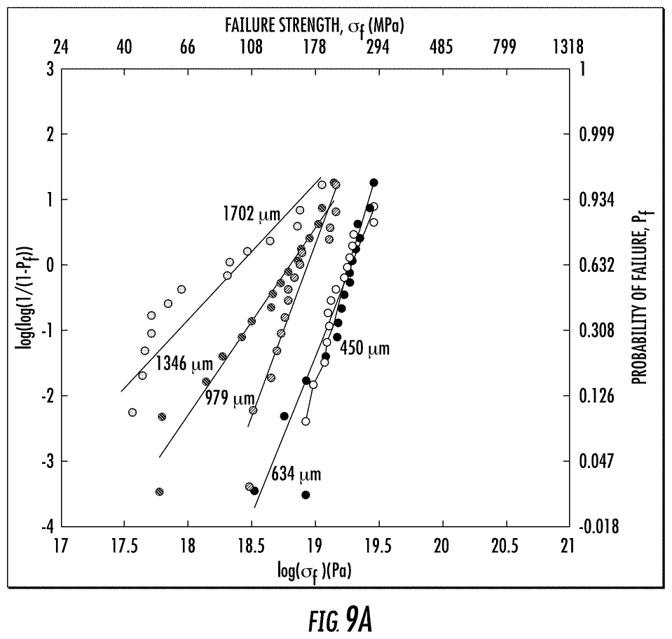

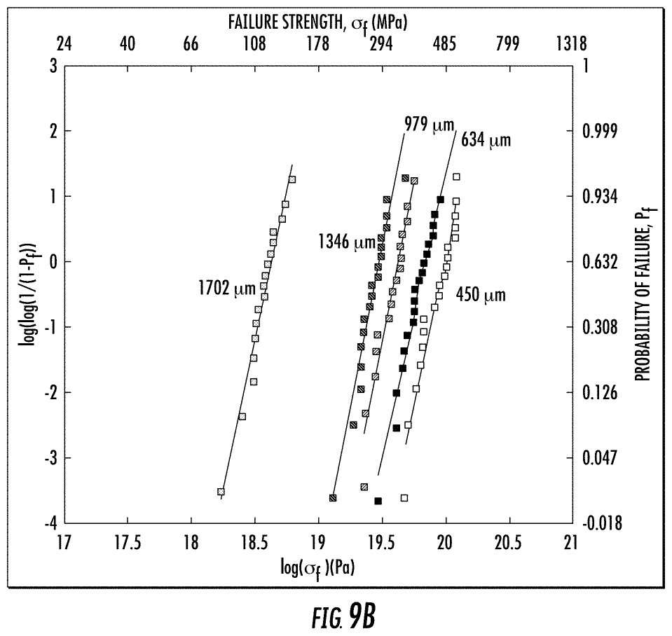

When strength data are plotted in this manner, a linear regression of the data provides the m as the slope of the linear fit and m ln σc as the y-intercept. Such plots for each family of printed microrods from both SMP-00 and SMP-FA are shown in FIGS. 9A and 9B, respectively. All average σ_{f}, σ_{c}, and m are shown in Table 5, below. SMP-00 m values vary from about 3 to 6.8, while SMP-FA varies from about 8.6 to 10. SMP-00 has much lower m and σ_{c} when compared to the SMP-FA at the same nozzle size, corresponding to a greater dispersion of strength values within one family of samples. The decrease in strength with increasing nozzle diameter for both inks corresponds to the increase in porosity size shown in FIGS. 4A and 4B. The diameter of the deposition nozzle affects how much porosity develops, which affects the strength of the rod. This size effect is expected from the weakest link theory for brittle fracture, which has been extensively explored. See Quinn and Quinn (2010); and Zok (2017).

TABLE 5
Nozzle size, number of samples tested, average failure
strength, characteristic strength, and Weibull
modulus for both SMP-00 and SMP-FA samples.

| | | | | |
|---|---|---|---|---|
| Nozzle | N, | Avg. Fracture | Char. | |
| Size | number of | Strength, | Strength, | Weibull |
| [μm] | samples | σf [MPa] | σc [MPa] | Modulus |

SMP-00

| | | | | |
|---|---|---|---|---|
| 450 | 17 | 219.6 | 235.2 | 6.79 |
| 634 | 16 | 218.4 | 238.9 | 4.82 |
| 979 | 15 | 155.8 | 169.2 | 5.30 |
| 1346 | 15 | 129.8 | 146.4 | 2.97 |
| 1702 | 15 | 86.4 | 98.3 | 3.29 |

SMP-FA

| | | | | |
|---|---|---|---|---|
| 450 | 19 | 457.6 | 483.3 | 8.93 |
| 634 | 20 | 394.6 | 417.4 | 8.58 |
| 979 | 16 | 318.2 | 334.3 | 9.94 |
| 1346 | 19 | 274.8 | 288.8 | 9.92 |
| 1702 | 17 | 116.5 | 122.7 | 9.36 |

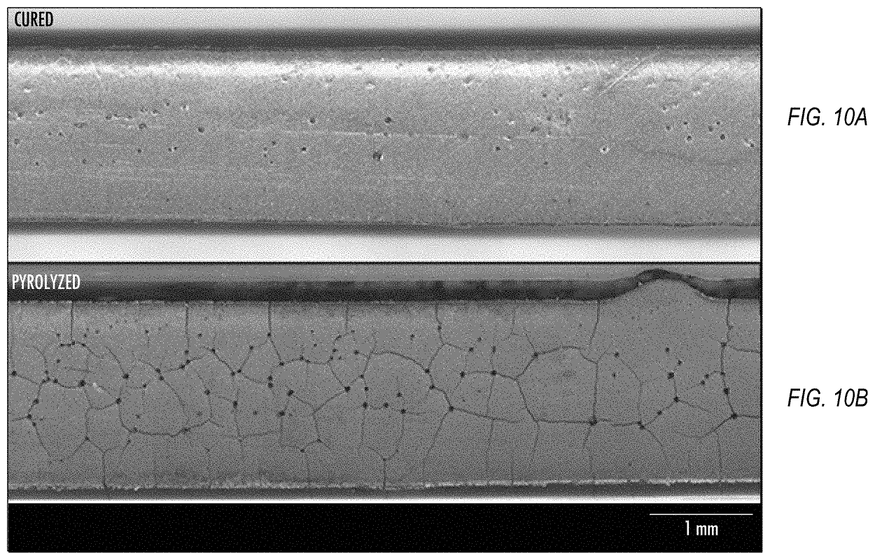

For both materials, there is a considerable shift in strength values for the largest samples tested. This reduction in strength for larger samples closely corresponds to the observed onset of cracking on the bottom surfaces of the larger sample (example shown in FIGS. 10A and 10B), which suggests that two separate flaw populations dictate the strength of printed polymer-derived ceramic composites: developed pores below a certain sample size, and cracks that form during pyrolysis dictate strength.

Accordingly, the effect of microrod size and ink composition on the development of porosity and σ_{f} was investigated. Preceramic resin-based inks were used to deposit 32 mm long microrods of varying diameters. Microrods printed from both inks using a variety of nozzle diameters were tested with 3 pt. bend testing and analyzed with Weibull analysis. With increased nozzle size, an increase in porosity size occurred, leading to a decrease in flexural strength. The addition of 6 vol. % of FA increased the strength at a given nozzle diameter.

### Example 2

### SMP-75 Ink

Another ink formulation (referred to herein as “SMP-75”) was prepared using 66.7 vol % SMP-75 (Starfire Systems Inc., Schenectady, N.Y., United States of America), an allylhydridopolycarbosilane, or simply polycarbosilane, as the base polymer resin; 16.45 vol % FA (sold under the tradename AEROXIDE® Alu C 805, Evonik Industries, Essen, Germany), and 16.8 vol % silicon carbide whiskers (Haydale SF-1, Haydale Technologies, Inc., Greer, S.C., United States of America). SMP-75 and SMP-10 have different ratios of carbon to silicon in their backbone, with SMP-75 having a higher ratio of carbon to silicon than SMP-10.

The ink composition was printed using a 0.577 micron-diameter, tapered nozzle using an extrusion pressure of 172 (kPa) (25 psi) with a print speed of 18.3 mm/s. Target as printed dimensions for SMP-75 bars were 31.2×2.2×1.7 mm (slightly oversized to account for an expected 4% linear shrinkage). The SMP-75 bars were cured at 230° C.

The SMP-75 bars were pyrolyzed using the following schedule:
1. 5° C./min to 350° C.
2. 1 hour hold
3. 1° C./min to 550° C.
4. 1 hour hold
5. 1° C./min to 1200° C.
6. 2 hour hold
7. 1° C./min to 550° C.
8. 1 hour hold
9. 1° C./min to 350° C.
10. 5° C./min to room temperature

The average mass loss during pyrolysis was 9.45±0.75%. The average linear shrinkage was 1.40±0.67%.

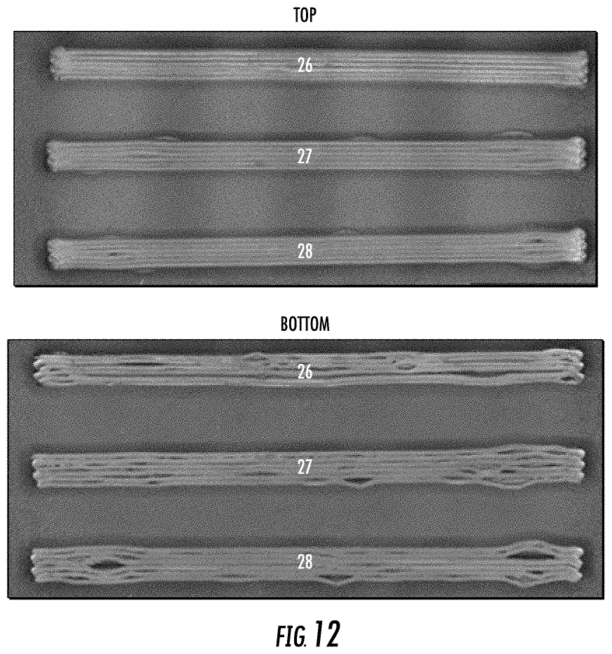

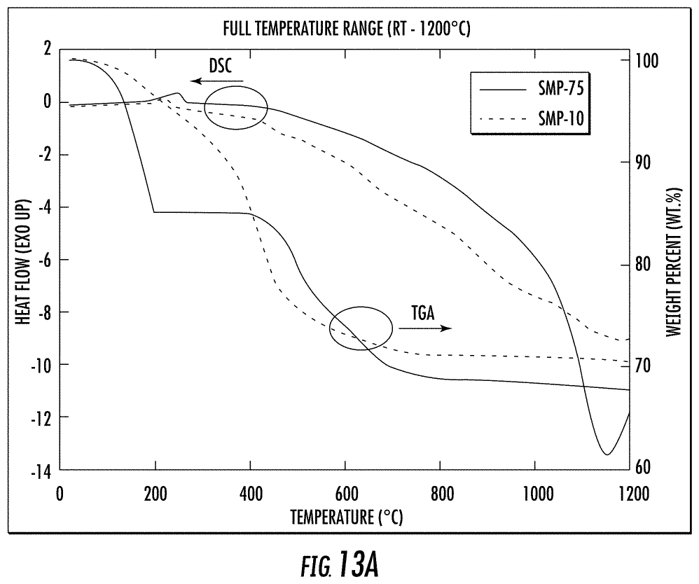

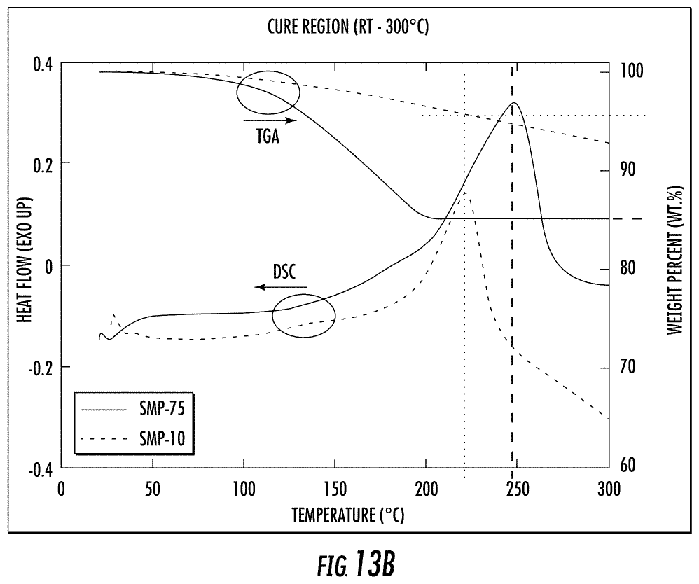

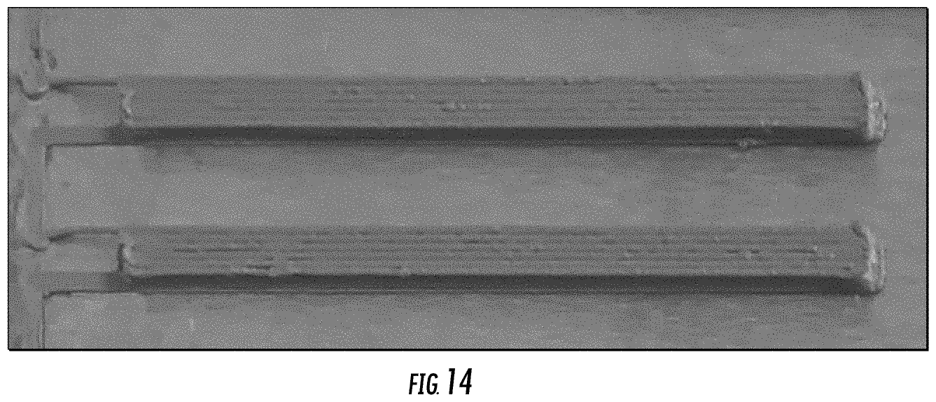

FIG. 12 shows top and bottom images of cured SMP-75 bars. FIGS. 13A and 13B show simultaneous DSC/TGA analysis comparing the SMP-FA ink composition from Example 1 (also referred to as SMP-10) to the SMP-75 ink. For the SMP-75 ink, peak exotherm was at about 250° C. with a mass loss at peak exotherm of about 15%. In comparison, for SMP-FA (SMP-10), the peak exotherm was at about 220° C., with a mass loss at peak exotherm of about 5%. SMP-75 loses more mass during ramp up to curing temperature than SMP-FA (SMP-10). This appeared to result in porosity in the printed bars. Pretreatment at 150° C. or in vacuum prior to formulation will be performed to mitigate the porosity that arises during curing.

### Example 3

### Polysilazane Ink

An ink composition was prepared as follows:

66.1 vol % polysilazane resin (sold under the tradename DURAZANE® 1800 (Merck KGaA, Darmstadt, Germany)

16.8 vol % FA (sold under the tradename AEROXIDE® Alu C 805, Evonik Industries, Essen, Germany), and

17.1 vol % silicon carbide whiskers (Haydale SF-1, Haydale Technologies, Inc., Greer, S.C., United States of America).

The polysilazane sold under the tradename DURAZANE® 1800 is a polysilazane resin with alternating Si and N atoms on the polymer backbone and methyl and vinyl functional groups in a ratio of 1:4 respectively. See D'Elia et al. (2018). The resin is a low-viscosity, colorless liquid with a density of 1.0 g/cc.

The ink composition was printed using a 0.577 micron-diameter, tapered nozzle using an extrusion pressure of 552 (kPa) (80 psi) with a print speed of 18.3 mm/s. Target as printed dimensions for bars were 31.2×2.2×1.7 mm (slightly oversized to account for an expected 4% linear shrinkage). The printed bars were cured at 230° C. FIG. 14 shows an image of the cured bars.

### REFERENCES

All references listed herein, including but not limited to all patents, patent applications and publications thereof, scientific journal articles, conference papers, and books, are incorporated herein by reference in their entireties to the extent that they supplement, explain, provide a background for, or teach methodology, techniques, and/or compositions employed herein.
Apostolov, Z. D., Heckman, E. P., Key, T. S., Cinibulk, M. K., Effects of low-temperature treatment on the properties of commercial preceramic polymers, J. Eur. Ceram. Soc. 40 (2020) 2887-2895. doi.org/10.1016/j.jeurceramsoc.2020.02.030.
Bera, O., Joviči\ddot{c}, M., Pavličevi\ddot{c}, J., B. Pili\ddot{c}, B. The influence of oxide nanoparticles on the kinetics of free radical methyl methacrylate polymerization in bulk, Polym. Compos. 34 (2013) 1342-1348. doi.org/10.1002/pc.22548.
Campbell, C. G., Astorga, D. J., Duemichen, E., Celina, M. Thermoset materials characterization by thermal desorption or pyrolysis based gas chromatography-mass spectrometry methods, Polym. Degrad. Stab. 174 (2020) 109032. doi.org/10.1016/j.polymdegradstab.2019.109032.
Colombo, P., Mera, G., Riedel, R., G. D. Sorarù, G. D. Polymer-Derived Ceramics: 40 Years of Research and Innovation in Advanced Ceramics, J. Am. Ceram. Soc. 4 (2010) 245-320. doi.org/10.1002/9783527631971.ch07.
Compton, B. G., Hmeidat, N. S., Pack, R. C., Heres, M. F., J. R. Sangoro, J. R., Electrical and mechanical properties of 3D-printed graphene-reinforced epoxy, Jom. 70 (2018) 292-297.
Conrad, J. C., Ferreira, S. R., Yoshikawa, J., Shepherd, R. F., Ahn, B. Y., Lewis, J. A. Designing colloidal suspensions for directed materials assembly, Curr. Opin. Colloid Interface Sci. 16 (2011) 71-79. doi.org/10.1016/j.cocis.2010.11.002.
D'Elia, R., Dusserre, G., Del Confetto, S., Eberling-Fux, N., Descamps, C., Cutard, T., Effect of dicumyl peroxide concentration on the polymerization kinetics of a polysilazane system, Polym. Eng. Sci. 58 (2018) 859-869. doi.org/10.1002/pen.24638.
Dinkgreve, M., Paredes, J., Denn, M. M., Bonn, D., On different ways of measuring “the” yield stress, J. Nonnewton. Fluid Mech. 238 (2016) 233— 241. doi.org/10.1016/j.jnnfm.2016.11.001.
Franchin, G., Maden, H. S., Wahl, L., Baliello, A., Pasetto, M., Colombo, P. Optimization and characterization of preceramic inks for Direct Ink Writing of Ceramic Matrix Composite structures, Materials (Basel). 11 (2018) 515. doi.org/10.3390/ma11040515.
Greil, P. Polymer derived engineering ceramics, Adv. Eng. Mater. 2 (2000) 339-348.
Hmeidat, N. S., Kemp, J. W., B. G. Compton, B. G. High-strength epoxy nanocomposites for 3D printing, Compos. Sci. Technol. 160 (2018) 9-20. doi.org/10.1016/j.compscitech.2018.03.008.
Kanarska, Y., Duoss, E. B., Lewicki, J. P., Rodriguez, J. N., Wu, A. Fiber motion in highly confined flows of carbon fiber and non-Newtonian polymer, J. Nonnewton. Fluid Mech. 265 (2019) 41-52. doi.org/10.1016/j.jnnfm.2019.01.003.
Kemp, J. W., Diaz, A. A., Malek, E. C., Croom, B. P., Apostolov, Z. D., Kalidindi, S. R., Compton, B. G., Rueschhoff, L. M. Direct ink writing of ZrB₂—SiC chopped fiber ceramic composites, Addit. Manuf. 44 (2021) 102049. doi.org/10.1016/j.addma.2021.102049.
Key, T. S., Wilks, G. B., Parthasarathy, T. A., King, D. S., Apostolov, Z. D., Cinibulk, M. K. Process modeling of the low-temperature evolution and yield of polycarbosilanes for ceramic matrix composites, J. Am. Ceram. Soc. 101 (2018) 2809-2818. doi.org/10.1111/jace.15463.
Lewis, J. A. Colloidal processing of ceramics, J. Am. Ceram. Soc. 83 (2000) 2341-2359. doi.org/10.1111/j.1151-2916.2000.tb01560.x.
Lewis, J. A., Smay, J. E., Stuecker, J., Cesarano, J. Direct ink writing of three-dimensional ceramic structures, J. Am. Ceram. Soc. 89 (2006) 3599-3609. doi.org/10.1111/j.1551-2916.2006.01382.x.
Medalia, A. I. Dynamic shape factors of particles, Powder Technol. 4 (1971) 117-138. doi.org/10.1016/0032-5910(71)80021-9.
Potticary, S. A. Chemical and Behavioral Study of Commercial Polycarbosilanes for the Processing of SiC Fibers, Masters Thesis, University of Cincinnati (2017). rave.ohiolink.edu/etdc/view?acc_num=ucin1512038635219321.
Quinn, J. B., Quinn, G. D. A practical and systematic review of Weibull statistics for reporting strengths of dental materials, Dent. Mater. 26 (2010) 135-147. doi.org/10.1016/j.dental.2009.09.006.
Raghavan, S. R., Khan, S. A. Shear-induced microstructural changes in flocculated suspensions of fumed silica, J. Rheol. (N. Y. N. Y). 39 (1995) 1311-1325. doi.org/10.1122/1.550638.
Romberg, S. K., Islam, M. A., Hershey, C. J., DeVinney, M., Duty, C. E., Kunc, V., Compton, B. G., Linking thermoset ink rheology to the stability of 3D-printed structures, Addit. Manuf. 37 (2021) 101621. doi.org/10.1016/j.addma.2020.101621.
Smay, J. E., Cesarano, J., Lewis, J. A. Colloidal inks for directed assembly of 3-D periodic structures, Langmuir. 18 (2002) 5429-5437. doi.org/10.1021/1a0257135.
Therriault, D., White, S. R., Lewis, J. A. Rheological behavior of fugitive organic inks for direct-write assembly, Appl. Rheol. 17 (2007) 10111— 10112. doi.org/10.1515/arh-2007-0001.
Wachtman, J. B., Cannon, W. R., Mathewson, M. J. Mechanical Properties of Ceramics, 2nd Edition, 2nd ed., John Wiley & Sons, Inc., 2009.
Xiao, J., Jia, Y, Liu, D., Cheng, H. Three-dimensional printing of SiCN ceramic matrix composites from preceramic polysilazane by digital light processing, Ceram. Int. 46 (2020) 25802-25807. doi.org/10.1016/j.ceramint.2020.07.061.
Zhu, C., Smay, J. E. Catenary shape evolution of spanning structures in direct-write assembly of colloidal gels, J. Mater. Process. Technol. 212 (2012) 727-733. doi.org/10.1016/j.jmatprotec.2011.04.005.
Zhu, K., Yang, D., Yu, Z., Ma, Y., Zhang, S., Liu, R., Li, J., Cui, J., Yuan, Y., Additive manufacturing of SiO₂—Al₂O3 refractory products via Direct Ink Writing, Ceram. Int. 46 (2020) 27254-27261. doi.org/10.1016/j.ceramint.2020.07.210.
Zocca, A., Franchin, G., Elsayed, H., Gioffredi, E., Bernardo, E., Colombo, P., Bandyopadhyay, A. Direct Ink Writing of a Preceramic Polymer and Fillers to Produce Hardystonite (Ca₂ZnSi₂O₇) Bioceramic Scaffolds, J. Am. Ceram. Soc. 99 (2016) 1960-1967. doi.org/10.1111/jace.14213.
Zok, F. W. On weakest link theory and Weibull statistics, J. Am. Ceram. Soc. 100 (2017) 1265-1268. doi.org/10.1111/jace.14665.

It will be understood that various details of the presently disclosed subject matter may be changed without departing from the scope of the presently disclosed subject matter. Furthermore, the foregoing description is for the purpose of illustration only, and not for the purpose of limitation.

What is claimed is:

1. A composition comprising:
(a) a preceramic resin; and
(b) a rheology modifier, wherein the rheology modifier comprises a fumed alumina.

2. The composition of claim 1, wherein the fumed alumina comprises hydrophobic fumed alumina.

3. The composition of claim 1, further comprising one or more fillers.

4. The composition of claim 3, wherein the one or more fillers comprise a composition selected from the group consisting of zirconia, alumina, silicon carbide, silicon nitride, aluminum nitride, boron nitride, titanium diboride, boron carbide, zirconium diboride (ZrB₂), carbon, an oxide, and titanium carbide.

5. The composition of claim 4, wherein the one or more fillers comprise ZrB₂ particles or silicon carbide whiskers.

6. The composition of claim 1, wherein the preceramic resin comprises a polycarbosilane resin or a polysilazane resin.

7. The composition of claim 1, wherein the composition comprises about 40 percent by volume (vol %) to about 97 vol % preceramic resin.

8. The composition of claim 1, wherein the composition comprises about 3 vol % to about 25 vol % fumed alumina.

9. The composition of claim 8, wherein the composition comprises about 4 vol % to about 17 vol % fumed alumina.

10. The composition of claim 1, wherein the composition comprises about 51.7 vol % polycarbosilane resin; about 5.95 vol % fumed alumina; and about 42.4 vol % zirconium diboride filler.

11. The composition of claim 1, wherein the composition comprises about 66.7 vol % polycarbosilane resin; about 16.45 vol % fumed alumina; and about 16.8 vol % silicon carbide whiskers.

12. The composition of claim 1, wherein the composition comprises about 66.1 vol % polysilazane resin; about 16.8 vol % fumed alumina; and about 17.1 vol % silicon carbide whiskers.

13. A method of preparing a ceramic object, the method comprising:
(a) printing a composition of claim 1; and
(b) curing and pyrolyzing the ink composition to provide the ceramic object.

14. A ceramic object prepared by the method of claim 13.

15. The ceramic object of claim 14, wherein the ceramic object has a higher flexural strength and/or Weibull modulus than a ceramic object of the same size prepared from an ink composition not including fumed alumina.

16. A ceramic object comprising a pyrolyzed composition of claim 1.

17. The ceramic object of claim 16, wherein the ceramic object has a higher flexural strength and/or Weibull modulus than a ceramic object of the same size prepared from an ink composition not including fumed alumina.

18. A ceramic object comprising a ceramic matrix and fumed alumina.

19. The ceramic object of claim 18, further comprising one or more fillers, wherein the one or more fillers comprise a composition selected from the group consisting of zirconia, alumina, silicon carbide, silicon nitride, aluminum nitride, boron nitride, titanium diboride, boron carbide, ZrB₂, carbon, an oxide, and titanium carbide.

20. The ceramic object of claim 18, further comprising ZrB₂ particles or silicon carbide whiskers.
